(19) United States
(12) Patent Application Publication
(10) Pub. No.: US 2026/0186276 A1
(43) Pub. Date: Jul. 2, 2026

(54) IMAGING OPTICAL LENS

(71) Applicant: Changzhou AAC Raytech Optronics Co., Ltd., Changzhou City (CN)

(72) Inventor: Zhe Huang, Changzhou (CN)

(21) Appl. No.: 19/330,783

(22) Filed: Sep. 16, 2025

Related U.S. Application Data
(63) Continuation of application No. PCT/CN2024/144079, filed on Dec. 31, 2024.

(51) Int. Cl. G02B 13/00; G02B 13/02

(52) U.S. Cl. CPC G02B 13/007; G02B 13/0045; G02B 13/009; G02B 13/02

(57) ABSTRACT

Disclosed is an imaging optical lens, the imaging optical lens includes a first prism, a first lens group, and a second lens group. The first lens group includes a first lens and a second lens, and the second lens group includes a third lens, a fourth lens, and a fifth lens. The first lens group is movable for adjustment, satisfying the following relationships: 4.00≤fA/IH≤4.60; −4.00≤Rp1/Rp2≤−0.14; 0.30≤d1/d3≤1.20; −2.90≤(R7+R8)/(R7−R8)≤−1.20.

### TECHNICAL FIELD

Embodiments of the present disclosure relate to the technical field of optics, and in particular to an imaging optical lens.

### BACKGROUND

With the rapid development and popularization of smart mobile phones, the research, development, and design of camera technology have advanced significantly. In addition, as electronic products nowadays tend to have excellent functions and a compact and lightweight design, miniaturized cameras with good imaging quality have become mainstream in the current market. Among them, inner focusing cameras, due to their characteristics such as high stability, fast focusing, good cleanliness, and the ability to address the wear issue of external focusing, have been gradually developed and applied in mobile phone cameras.

Additionally, telephoto cameras can meet consumers' needs for capturing specific targets. Traditional telephoto cameras have an excessively long total optical length, which cannot meet the lightweight and thin design requirements of smart mobile phones. However, the periscope telephoto camera design can significantly shorten the total optical length of the imaging optical lens while meeting the telephoto design. Nevertheless, the optical performance of existing periscope telephoto imaging optical lenses still cannot meet the practical requirements.

### SUMMARY

The embodiments of the present disclosure are intended to provide an imaging optical lens that can reduce the total optical length of the optical lens, meet the requirements of focusing movement, achieve a telephoto periscope design, and exhibit good optical performance.

In order to solve the above technical problems, the embodiments of the present disclosure provide an imaging optical lens. The imaging optical lens includes, in sequence from the object-side to the image-side:
a first prism with positive refractive power;
a first lens with negative refractive power;
a second lens with positive refractive power;
a third lens with negative refractive power;
a fourth lens with positive refractive power; and
a fifth lens with negative refractive power;
a reflective surface is arranged between the object-side surface and the image-side surface of the first prism;
the first lens and the second lens form a first lens group, and the third lens, the fourth lens, and the fifth lens form a second lens group, the first lens group is configured to be movable along the optical axis of the imaging optical lens for adjustment, enabling the imaging optical lens to switch between a first state and a second state, where the imaging optical lens has the maximum focal length in the first state and the minimum focal length in the second state;
fA represents a focal length of the imaging optical lens in the first state;
IH represents an image height of the imaging optical lens;
Rp1 represents a curvature radius of the object-side surface of the first prism;
Rp2 represents a curvature radius of the image-side surface of the first prism;
d1 represents an on-axis thickness of the first lens;
d3 represents an on-axis thickness of the second lens;
R7 represents a curvature radius of the object-side surface of the fourth lens;
R8 represents a curvature radius of the image-side surface of the fourth lens;
and the imaging optical lens satisfies the following relationships:

$$4. \leq fA / IH \leq 4.6 ;$$

$$- 4. \leq Rp 1 / Rp 2 \leq - 0.14 ;$$

$$0.3 \leq d 1 / d 3 \leq 1.2 ;$$

$$- 2.9 \leq ( R 7 + R 8 ) / ( R 7 - R 8 ) \leq - 1.2 .$$

In some embodiments, the imaging optical lens satisfies the following relationships: 4.38≤fA/IH≤4.53; −3.90≤Rp1/Rp2≤−0.14; −2.90≤(R7+R8)/(R7−R8)≤−1.19.

In some embodiments, an object-side surface of the first prism is convex in a paraxial region, and an image-side surface of the first prism is convex in a paraxial region; fp1 represents a focal length of the first prism, and the imaging optical lens satisfies the following relationship: 0.92≤fp1/fA≤1.23.

In some embodiments, an object-side surface of the first lens is convex in a paraxial region, and an image-side surface of the first lens is concave in a paraxial region; f1 represents a focal length of the first lens, R1 represents a curvature radius of the object-side surface of the first lens, R2 represents a curvature radius of the image-side surface of the first lens, TTL represents a total optical length of the imaging optical lens; and the imaging optical lens satisfies the following relationships: −1.012≤f1/fA≤−0.943; 3.33≤(R1+R2)/(R1−R2)≤4.00; 0.034≤d1/TTL≤0.061.

In some embodiments, an object-side surface of the second lens is convex in a paraxial region, and an image-side surface of the second lens is convex in a paraxial region; f2 represents a focal length of the second lens, R3 represents a curvature radius of the object-side surface of the second lens, R4 represents a curvature radius of the image-side surface of the second lens, TTL represents a total optical length of the imaging optical lens; and the imaging optical lens satisfies the following relationships: 0.412≤f2/fA≤0.455; −0.094≤(R3+R4)/(R3−R4)≤−0.038; 0.050≤d3/TTL≤0.115.

In some embodiments, an object-side surface of the third lens is concave in a paraxial region, and an image-side surface of the third lens is concave in a paraxial region; f3 represents a focal length of the third lens, R5 represents a curvature radius of the object-side surface of the third lens, R6 represents a curvature radius of the image-side surface of the third lens, d5 represents an on-axis thickness of the third lens, TTL represents a total optical length of the imaging optical lens; and the imaging optical lens satisfies the following relationships: −0.475≤f3/fA≤−0.450; −0.58≤(R5+R6)/(R5−R6)≤−0.44; 0.019≤d5/TTL≤0.095.

In some embodiments, an object-side surface of the fourth lens is convex in a paraxial region, and an image-side surface of the fourth lens is concave in a paraxial region; f4 represents a focal length of the fourth lens, d7 represents an on-axis thickness of the fourth lens, TTL represents a total optical length of the imaging optical lens; and the imaging optical lens satisfies the following relationships: 0.98≤f4/fA≤1.15; 0.041≤d7/TTL≤0.103.

In some embodiments, d5 represents an on-axis thickness of the third lens, d7 represents an on-axis thickness of the fourth lens; and the imaging optical lens satisfies the following relationship: 0.25≤d5/d7≤1.15.

In some embodiments, the imaging optical lens satisfies the following relationship: 0.29≤d5/d7≤1.15.

In some embodiments, an object-side surface of the fifth lens is convex in a paraxial region, and an image-side surface of the fifth lens is concave in a paraxial region; f5 represents a focal length of the fifth lens, R9 represents a curvature radius of the object-side surface of the fifth lens, R10 represents a curvature radius of the image-side surface of the fifth lens; and the imaging optical lens satisfies the following relationships: −1.93≤f5/fA≤−1.29; 4.31≤(R9+R10)/(R9−R10)≤6.33.

In some embodiments, the first prism is made of glass.

The beneficial effects of the embodiments of the present disclosure are as follows: By dividing the five lenses into a first lens group and a second lens group and moving the first lens group for focusing, the imaging optical lens achieves an inner focusing mode; Specifying the ratio of focal length to image height of the imaging optical lens in the first state enables the optical lens to have a longer focal length under a fixed image height, thereby enhancing the magnification of the imaging optical lenses. Optimizing the concave-convex shapes of the of the first prism and the fourth lens helps reduce the deflection degree of light passing through the optical elements, thus effectively decreasing aberrations. Meanwhile, reasonably distributing the on-axis thicknesses of the first lens and the second lens contributes to reducing the total optical length of the optical lens.

### BRIEF DESCRIPTION OF THE DRAWINGS

One or more embodiments are illustrated by the figures in the corresponding drawings, and these exemplified descriptions do not constitute limitations on the embodiments. Elements with the same reference numerals in the drawings represent similar elements, and the diagrams in the drawings do not constitute proportional limitations unless otherwise stated.

FIG. 1A is a schematic structural diagram of an imaging optical lens in a first embodiment of the present disclosure in a first state;

FIG. 1B is a schematic structural diagram of an imaging optical lens in a first embodiment of the present disclosure in a second state;

FIG. 2A, FIG. 3A, and FIG. 4A are respectively schematic diagrams of the field curvature and distortion, the longitudinal aberration, and the lateral color of the imaging optical lens shown in FIG. 1A;

FIG. 2B, FIG. 3B, and FIG. 4B are respectively schematic diagrams of the field curvature and distortion, the longitudinal aberration, and the lateral color of the imaging optical lens shown in FIG. 1B;

FIG. 5A is a schematic structural diagram of an imaging optical lens in a second embodiment of the present disclosure in the first state;

FIG. 5B is a schematic structural diagram of an imaging optical lens in a second embodiment of the present disclosure in the second state;

FIG. 6A, FIG. 7A, and FIG. 8A are respectively schematic diagrams of the field curvature and distortion, the longitudinal aberration, and the lateral color of the imaging optical lens shown in FIG. 5A;

FIG. 6B, FIG. 7B, and FIG. 8B are respectively schematic diagrams of the field curvature and distortion, the longitudinal aberration, and the lateral color of the imaging optical lens shown in FIG. 5B;

FIG. 9A is a schematic structural diagram of an imaging optical lens in a third embodiment of the present disclosure in the first state;

FIG. 9B is a schematic structural diagram of an imaging optical lens in a third embodiment of the present disclosure in the second state;

FIG. 10A, FIG. 11A, and FIG. 12A are respectively schematic diagrams of the field curvature and distortion, the longitudinal aberration, and the lateral color of the imaging optical lens shown in FIG. 9A;

FIG. 10B, FIG. 11B, and FIG. 12B are respectively schematic diagrams of the field curvature and distortion, the longitudinal aberration, and the lateral color of the imaging optical lens shown in FIG. 9B;

FIG. 13A is a schematic structural diagram of an imaging optical lens in a fourth embodiment of the present disclosure in the first state;

FIG. 13B is a schematic structural diagram of an imaging optical lens in a fourth embodiment of the present disclosure in the second state;

FIG. 14A, FIG. 15A, and FIG. 16A are respectively schematic diagrams of the field curvature and distortion, the longitudinal aberration, and the lateral color of the imaging optical lens shown in FIG. 13A;

FIG. 14B, FIG. 15B, and FIG. 16B are respectively schematic diagrams of the field curvature and distortion, the longitudinal aberration, and the lateral color of the imaging optical lens shown in FIG. 13B;

FIG. 17A is a schematic structural diagram of an imaging optical lens in a fifth embodiment of the present disclosure in the first state;

FIG. 17B is a schematic structural diagram of an imaging optical lens in a fifth embodiment of the present disclosure in the second state;

FIG. 18A, FIG. 19A, and FIG. 20A are respectively schematic diagrams of the field curvature and distortion, the longitudinal aberration, and the lateral color of the imaging optical lens shown in FIG. 17A;

FIG. 18B, FIG. 19B, and FIG. 20B are respectively schematic diagrams of the field curvature and distortion, the longitudinal aberration, and the lateral color of the imaging optical lens shown in FIG. 17B;

FIG. 21A is a schematic structural diagram of an imaging optical lens in a sixth embodiment of the present disclosure in the first state;

FIG. 21B is a schematic structural diagram of an imaging optical lens in a sixth embodiment of the present disclosure in the second state;

FIG. 22A, FIG. 23A, and FIG. 24A are respectively schematic diagrams of the field curvature and distortion, the longitudinal aberration, and the lateral color of the imaging optical lens shown in FIG. 21A;

FIG. 22B, FIG. 23B, and FIG. 24B are respectively schematic diagrams of the field curvature and distortion, the longitudinal aberration, and the lateral color of the imaging optical lens shown in FIG. 21B.

### DETAILED DESCRIPTION OF THE EMBODIMENTS

To make the objectives, technical solutions, and advantages of the embodiments of the present disclosure clearer, the following will describe each embodiment of the present disclosure in detail with reference to the accompanying drawings. However, those of ordinary skill in the art can understand that in each embodiment of the present disclosure, many technical details are proposed to enable readers to better understand the present disclosure. However, even without these technical details and various changes and modifications based on the following embodiments, the technical solutions claimed in the present disclosure can still be realized.

In the embodiments of the present disclosure, terms such as “upper”, “lower”, “left”, “right”, “front”, “rear”, “top”, “bottom”, “inner”, “outer”, “middle”, “vertical”, “horizontal”, “transverse”, and “longitudinal” indicate orientations or positional relationships based on the orientations or positional relationships shown in the drawings. These terms are mainly used to better describe the present disclosure and its embodiments, and are not intended to limit the indicated devices, elements, or components to have specific orientations or to be constructed and operated in specific orientations.

In addition, some of the above terms may also be used to indicate other meanings besides orientations or positional relationships. For example, the term “upper” may also be used to indicate a certain attachment or connection relationship in some cases. For those of ordinary skill in the art, the specific meanings of these terms in the present disclosure can be understood according to specific situations.

Moreover, the terms “installation”, “setting”, “providing”, “opening”, “connection”, and “connection” should be interpreted broadly. For example, it may be a fixed connection, a detachable connection, or an integral structure; it may be a mechanical connection or an electrical connection; it may be a direct connection or an indirect connection through an intermediate medium, or it may be internal communication between two devices, elements, or components. For those of ordinary skill in the art, the specific meanings of the above terms in the present disclosure can be understood according to specific situations.

In addition, the terms “first” and “second” are mainly used to distinguish different devices, elements, or components (the specific types and structures may be the same or different), and are not used to indicate or imply the relative importance and quantity of the indicated devices, elements, or components. Unless otherwise specified, “multiple” means two or more.

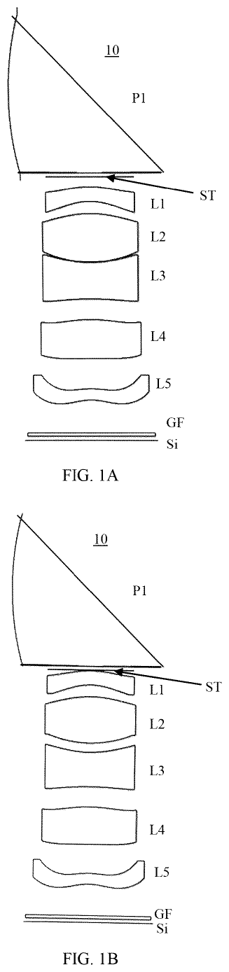

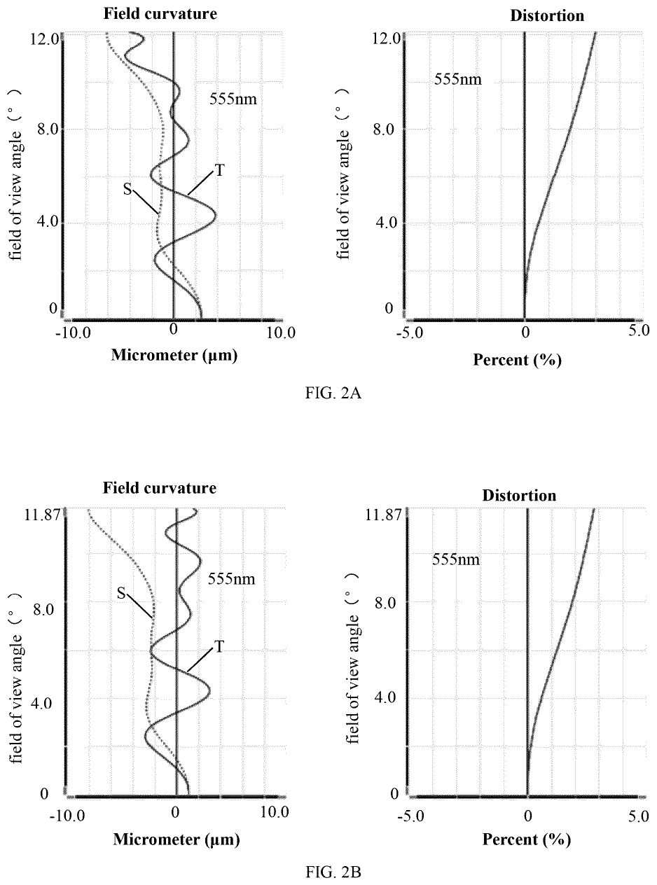

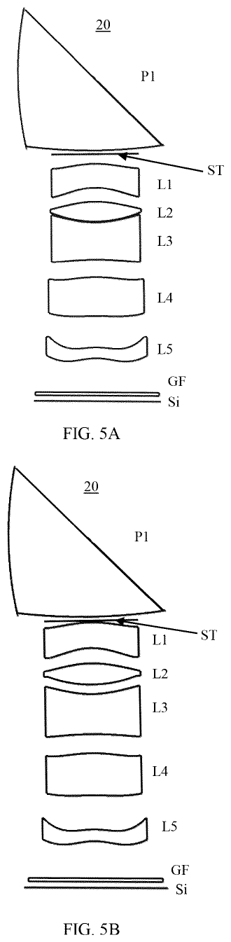

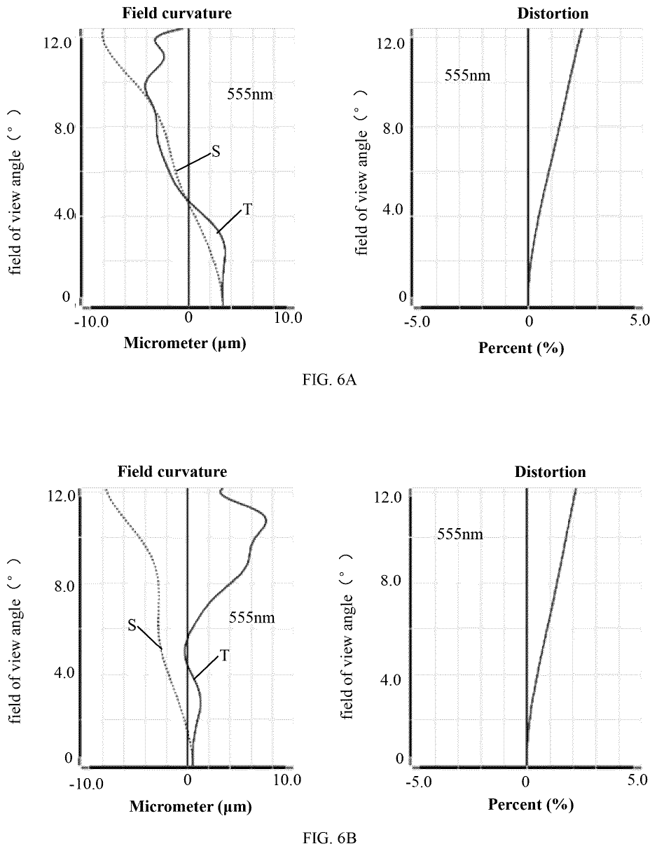

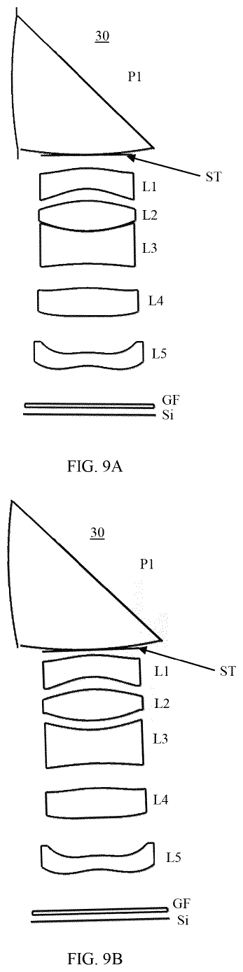

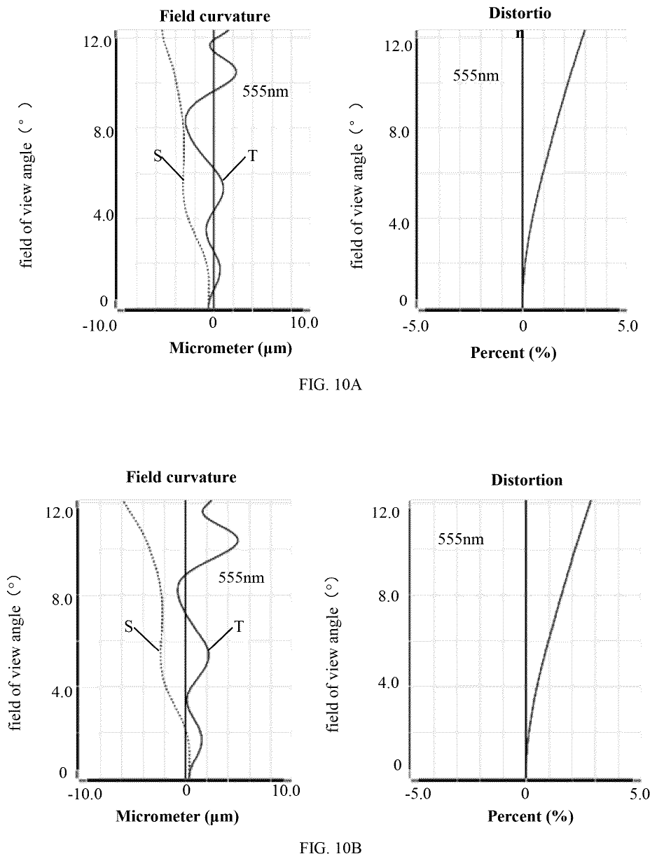

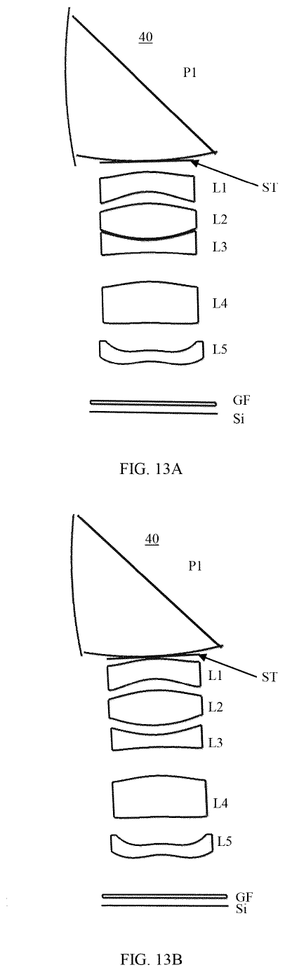

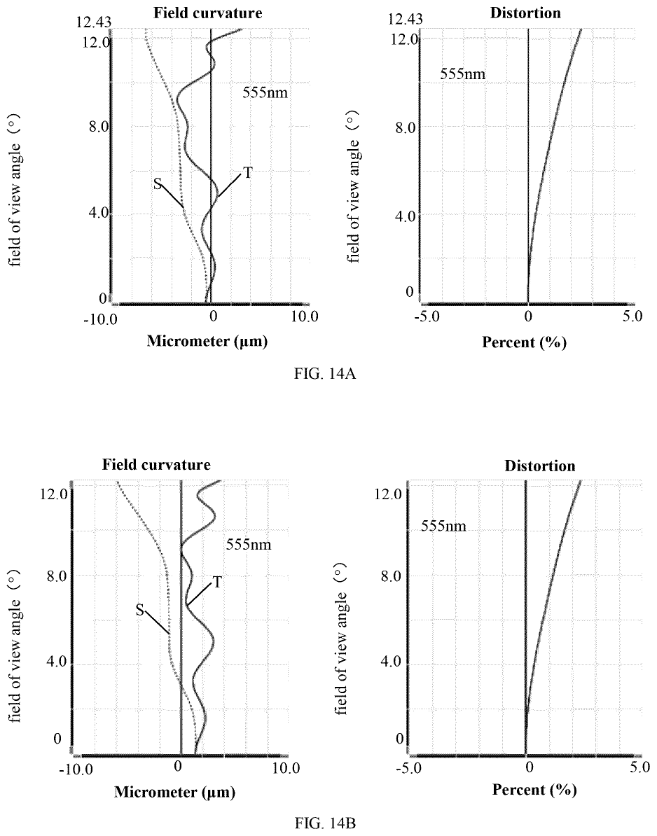

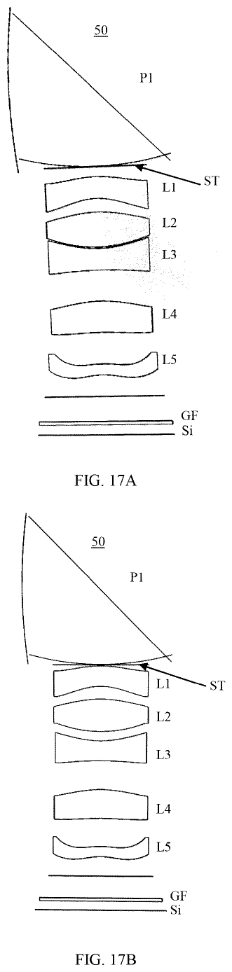

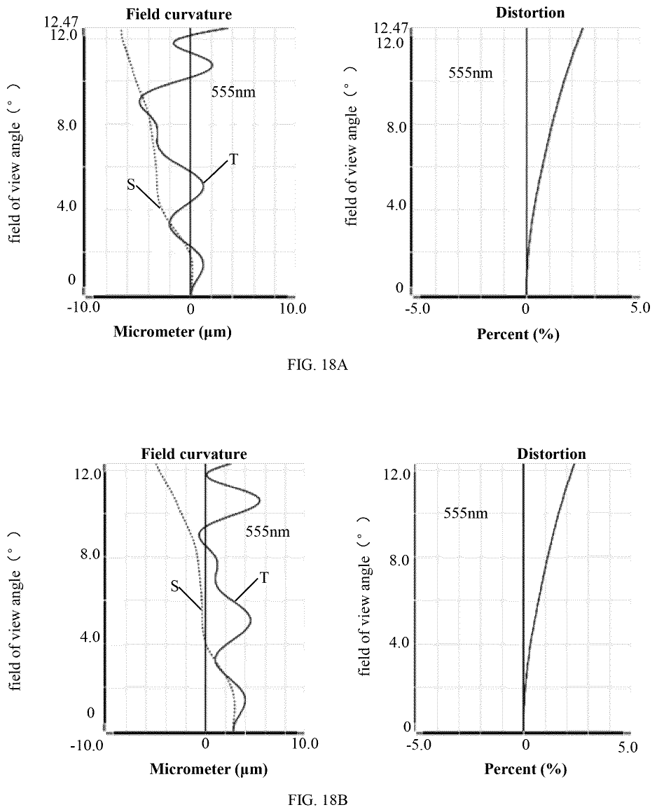

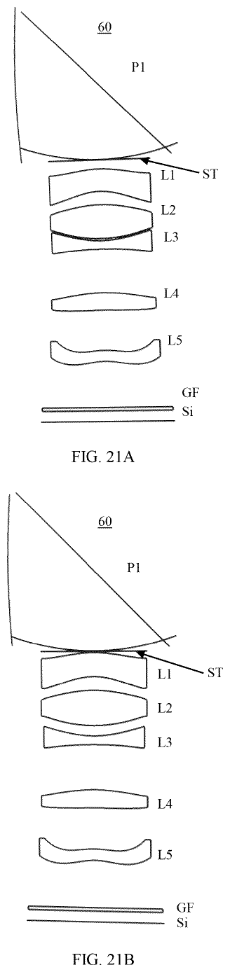

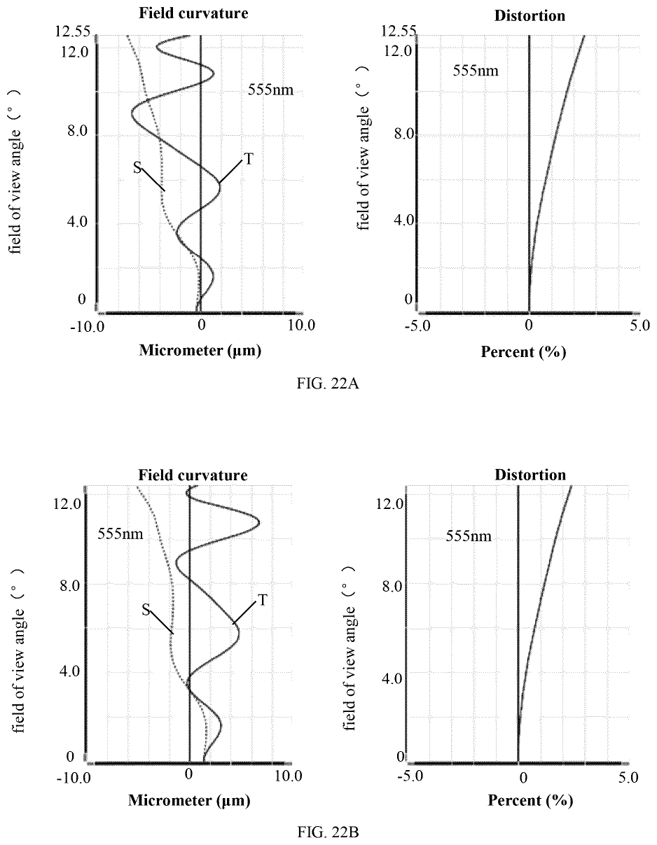

Referring to FIG. 1A, FIG. 1B, FIG. 5A, FIG. 5B, FIG. 9A, FIG. 9B, FIG. 13A, FIG. 13B, FIG. 17A, FIG. 17B, FIG. 21A, and FIG. 21B, the technical solution of the present disclosure provides imaging optical lenses 10, 20, 30, 40, 50, and 60. The imaging optical lenses 10, 20, 30, 40, 50, and 60 each include, in sequence from the object-side to the image-side, the following components: a first prism P1 with positive refractive power; a first lens L1 with negative refractive power; a second lens L2 with positive refractive power; a third lens L3 with negative refractive power; a fourth lens L4 with positive refractive power; and a fifth lens L5 with negative refractive power. A reflective surface is arranged between the object-side surface and the image-side surface of the first prism P1. The first lens L1 and the second lens L2 form a first lens group, while the third lens L3, the fourth lens L4, and the fifth lens L5 form a second lens group. The first lens group is configured to be movable along the optical axis of the imaging optical lenses 10, 20, 30, 40, 50, and 60 for adjustment, enabling the imaging optical lenses 10, 20, 30, 40, 50, and 60 to switch between a first state and a second state. In the first state, the imaging optical lenses 10, 20, 30, 40, 50, and 60 have the maximum focal length, while in the second state, the imaging optical lenses 10, 20, 30, 40, 50, and 60 have the minimum focal length.

A focal length of the imaging optical lenses 10, 20, 30, 40, 50, and 60 in the first state is defined as fA, an image height of the imaging optical lenses 10, 20, 30, 40, 50, and 60 is defined as IH, a curvature radius of the object-side surface of the first prism P1 is defined as Rp1, a curvature radius of the image-side surface of the first prism P1 is defined as Rp2, an on-axis thickness of the first lens L1 is defined as d1, an on-axis thickness of the second lens L2 is defined as d3, a curvature radius of the object-side surface of the fourth lens L4 is defined as R7, a curvature radius of the image-side surface of the fourth lens L4 is defined as R8, and the following relationship formulas should be satisfied:

$$4. \leq fA / IH \leq 4.6 \qquad ( 1 )$$

$$- 4. \leq Rp 1 / Rp 2 \leq - 0.14 \qquad ( 2 )$$

$$0.3 \leq d 1 / d 3 \leq 1.2 \qquad ( 3 )$$

$$- 2.9 \leq ( R 7 + R 8 ) / ( R 7 - R 8 ) \leq - 1.2 . \qquad ( 4 )$$

The imaging optical lenses 10, 20, 30, 40, 50, and 60 are periscope optical lenses, each including five lenses. Each of the imaging optical lenses 10, 20, 30, 40, 50, and 60 includes a first prism P1, a first lens L1, a second lens L2, a third lens L3, a fourth lens L4, and a fifth lens L5, which are sequentially arranged from the object-side to the image-side.

The five lenses of the imaging optical lenses 10, 20, 30, 40, 50, and 60 are the first lens L1, the second lens L2, the third lens L3, the fourth lens L4, and the fifth lens L5. These five lenses are divided into two groups (the two lenses+the three lenses), namely the first lens group and the second lens group, with the first lens group positioned closer to the object-side than the second lens group.

The first lens group is a front group, including the first lens L1 and the second lens L2. The object-side surface of the first lens group is the object-side surface of the first lens L1, and the image-side surface of the first lens group is the image-side surface of the second lens L2. The second lens group is a rear group, including the third lens L3, the fourth lens L4, and the fifth lens L5. The object-side surface of the second lens group is the object-side surface of the third lens L3, and the image-side surface of the second lens group is the image-side surface of the fifth lens L5.

The first lens group is arranged between the first prism P1 and the second lens group and is configured to move along the optical axis of the imaging optical lenses 10, 20, 30, 40, 50, and 60, thereby adjusting the on-axis distance from the image-side surface of the first prism P1 to the object-side surface of the first lens group and the on-axis distance from the image-side surface of the first lens group to the object-side surface of the second lens group. Thus, the first lens group acts as a moving zoom group, while the second lens group serves as a fixed focal length group. The movement of the first lens group enables focal length changes of the imaging optical lenses 10, 20, 30, 40, 50, and 60, ensuring good imaging performance in both the first state and the second state. The first state refers to the state where the imaging optical lenses 10, 20, 30, 40, 50, and 60 have the maximum focal length, and the second state refers to the state where they have the minimum focal length. For example, the first state may be a telephoto state or an infinite object-distance state; the second state may be a short-focus state, a macro state, or a state with an object distance of 200 mm. Thus, the imaging optical lenses 10, 20, 30, 40, 50, and 60 can achieve inner focusing through the movement of the front group.

The Relationship formula (1) specifies the ratio range of the focal length fA in the first state to the image height (IH) of the imaging optical lenses 10, 20, 30, 40, 50, and 60. Within the range defined by the relationship formula (1), the imaging optical lenses 10, 20, 30, 40, 50, and 60 have a longer focal length under a fixed image height (IH), it helps to improve the magnification of the imaging optical lenses 10, 20, 30, 40, 50, and 60. More preferably, 4.38≤fA/IH≤4.53.

The relationship formula (2) specifies the ratio range of the curvature radius Rp1 of the object-side surface of the first prism P1 to the curvature radius Rp2 of the image-side surface of the first prism P1, controlling the concave-convex shapes of the object-side surface and the image-side surface of the first prism P1. Within the range defined by the relationship formula (2), it is beneficial to reduce the deflection degree of light passing through the first prism P1. More preferably, −3.90≤Rp1/Rp2≤−0.14.

The relationship formula (3) specifies the ratio range of the on-axis thickness d1 of the first lens L1 to the on-axis thickness d3 of the second lens L2. Within the range defined by the relationship formula (3), the on-axis thicknesses of the first lens L1 and the second lens L2 can be reasonably distributed, which helps to reduce the total optical length of the imaging optical lenses 10, 20, 30, 40, 50, and 60.

The relationship formula (4) specifies the concave-convex shapes of the object-side surface and the image-side surface of the fourth lens L4. Within the range defined by the relationship formula (4), it is beneficial to reduce the deflection degree of light passing through the fourth lens L4, which can well reduce aberrations. More preferably, −2.90≤(R7+R8)/(R7-R8)≤−1.19.

The beneficial effects of the present disclosure are as follows: By dividing the five lenses into a first lens group and a second lens group, and moving the first lens group for focusing, the imaging optical lenses 10, 20, 30, 40, 50, and 60 achieve an inner focusing mode. Specifying the ratio of the focal length to the image height of the imaging optical lenses 10, 20, 30, 40, 50, and 60 in the first state enables the imaging optical lenses 10, 20, 30, 40, 50, and 60 to have a longer focal length under a fixed image height, thereby enhancing the magnification of the imaging optical lenses 10, 20, 30, 40, 50, and 60. Optimizing the concave-convex shapes of the first prism P1 and the fourth lens L4 helps to reduce the deflection degree of light passing through the first prism P1 and the fourth lens L4, thus effectively decreasing aberrations. Meanwhile, reasonably distributing the on-axis thicknesses of the first lens L1 and the second lens L2 contributes to reducing the total optical length of the imaging optical lenses 10, 20, 30, 40, 50, and 60.

Based on the above relationships and achievable functions, the characteristics of each of the lenses are further detailed as follows.

Preferably, the focal length of the first prism P1 is defined as fp1, the sum of the on-axis distance from the object-side surface of the first prism P1 to the reflective surface and the on-axis distance from the reflective surface to the image-side surface of the first prism P1 is defined as dp1, and the total optical length of the imaging optical lenses 10, 20, 30, 40, 50, and 60 is defined as TTL. The following relationship formulas should be satisfied:

$$0.92 \leq fp 1 / fA \leq 1.23 \qquad ( 5 )$$

$$0.37 \leq dp 1 / TTL \leq 0.38 \qquad ( 6 )$$

The relationship formula (5) specifies the ratio range of the focal length fp1 of the first prism P1 to the focal length fA of the imaging optical lenses 10, 20, 30, 40, 50, and 60 in the first state. Within the range defined by the relationship formula (5), it is beneficial to improve the optical performance of the imaging optical lenses 10, 20, 30, 40, 50, and 60.

The relationship formula (6) specifies the ratio range of the total on-axis thickness dp1 of the first prism P1 to the total optical length TTL of the imaging optical lenses 10, 20, 30, 40, 50, and 60. Within the range defined by relationship (6), it is beneficial to control the total optical length TTL of the imaging optical lenses 10, 20, 30, 40, 50, and 60, facilitating the miniaturized design of the imaging optical lenses 10, 20, 30, 40, 50, and 60. More preferably, 0.372≤dp1/TTL≤0.374.

An object-side surface of the first prism P1 is convex in a paraxial region, and an image-side surface of the first prism P1 is convex in a paraxial region. The object-side surface and the image-side surface of the first prism P1 may be configured with other concave and convex distributions.

Preferably, a focal length of the first lens L1 is defined as f1, a curvature radius of the object-side surface of the first lens L1 is defined as R1, and a curvature radius of the image-side surface of the first lens L1 is defined as R2. The following relationship formulas should be satisfied:

$$- 1.012 \leq f 1 / fA \leq - 0.943 \qquad ( 7 )$$

$$3.33 \leq ( R 1 + R 2 ) / ( R 1 - R 2 ) \leq 4. \qquad ( 8 )$$

$$0.034 \leq d 1 / TTL \leq 0.061 . \qquad ( 9 )$$

The relationship formula (7) specifies the ratio range of the focal length f1 of the first lens L1 to the focal length fA of the imaging optical lenses 10, 20, 30, 40, 50, and 60 in the first state. Within the range defined by the relationship formula (7), by controlling the negative refractive power of the first lens L1 within a reasonable range, it is beneficial to correct aberrations of the optical system.

The relationship formula (8) specifies the concave-convex shapes of the object-side surface and the image-side surface of the first lens L1. Within the range defined by relationship (8), even as the imaging optical lenses 10, 20, 30, 40, 50, and 60 develop toward miniaturization, it is beneficial to correct axial chromatic aberrations.

The relationship formula (9) specifies the ratio range of the on-axis thickness d1 of the first lens L1 to the total optical length TTL of the imaging optical lenses 10, 20, 30, 40, 50, and 60. Within the range defined by relationship (9), it is beneficial to control the total optical length TTL of the imaging optical lenses 10, 20, 30, 40, 50, and 60, facilitating the miniaturized design of the imaging optical lenses 10, 20, 30, 40, 50, and 60.

The object-side surface of the first lens L1 is convex in a paraxial region, and the image-side surface of the first lens L1 is concave in a paraxial region. The object-side surface and the image-side surface of the first lens L1 may be configured with other concave and convex distributions.

Preferably, a focal length of the second lens L2 is defined as f2, a curvature radius of the object-side surface of the second lens L2 is defined as R3, and a curvature radius of the image-side surface of the second lens L2 is defined as R4. The following relationship formulas should be satisfied:

$$0.412 \leq f 2 / fA \leq 0.455 \qquad ( 10 )$$

$$- 0.094 \leq ( R 3 + R 4 ) / ( R 3 - R 4 ) \leq - 0 \text{.038} \qquad ( 11 )$$

$$0.05 \leq d 3 / TTL \leq 0.115 \qquad ( 12 )$$

The relationship formula (10) specifies the ratio range of the focal length f2 of the second lens L2 to the focal length fA of the imaging optical lenses 10, 20, 30, 40, 50, and 60 in the first state. Within the range defined by relationship (10), it is beneficial to correct aberrations of the optical system and improve the imaging quality of the imaging optical lenses 10, 20, 30, 40, 50, and 60.

The relationship formula (11) specifies the concave-convex shapes of the object-side surface and the image-side surface of the second lens L2. Within the range defined by relationship (11), even as the imaging optical lenses 10, 20, 30, 40, 50, and 60 develop toward miniaturization, it is beneficial to correct axial chromatic aberrations.

The relationship formula (12) specifies the ratio range of the on-axis thickness d3 of the second lens L2 to the total optical length TTL of the imaging optical lenses 10, 20, 30, 40, 50, and 60. Within the range defined by relationship (12), it is beneficial to control the total optical length TTL of the imaging optical lenses 10, 20, 30, 40, 50, and 60, realizing the miniaturization design of the imaging optical lenses 10, 20, 30, 40, 50, and 60.

The object-side surface of the second lens L2 is convex in a paraxial region, and the image-side surface of the second lens L2 is convex in a paraxial region. The object-side surface and the image-side surface of the second lens L2 may be configured with other concave and convex distributions.

Preferably, the focal length of the third lens L3 is defined as f3, the on-axis thickness of the third lens L3 is defined as d5, the curvature radius of the object-side surface of the third lens L3 is defined as R5, and the curvature radius of the image-side surface of the third lens L3 is defined as R6. The following relationship formulas should be satisfied:

$$- 0.475 \leq f 3 / fA \leq - 0.450 \qquad ( 13 )$$

$$- 0.58 \leq ( R 5 + R 6 ) / ( R 5 - R 6 ) \leq - 0 \text{.44} \qquad ( 14 )$$

$$0.019 \leq d 5 / TTL \leq 0.0 95. \qquad ( 15 )$$

The relationship formula (13) specifies the ratio range of the focal length f3 of the third lens L3 to the focal length fA of the imaging optical lenses 10, 20, 30, 40, 50, and 60 in the first state. Within the range defined by relationship (13), through reasonable distribution of refractive power, the system has better imaging quality and lower sensitivity.

The relationship formula (14) specifies the concave-convex shapes of the object-side surface and the image-side surface of the third lens L3. Within the range defined by relationship (14), the deflection degree of light passing through the third lens L3 can be reduced, thereby effectively reducing aberrations.

The relationship formula (15) specifies the ratio range of the on-axis thickness d5 of the third lens L3 to the total optical length TTL of the imaging optical lenses 10, 20, 30, 40, 50, and 60. Within the range defined by relationship (15), it is beneficial to control the total optical length TTL of the imaging optical lenses 10, 20, 30, 40, 50, and 60, facilitating the miniaturized design of the imaging optical lenses 10, 20, 30, 40, 50, and 60.

The object-side surface of the third lens L3 is concave in a paraxial region, and the image-side surface of the third lens L3 is concave in a paraxial region. The object-side surface and the image-side surface of the third lens L3 may be configured with other concave and convex distributions.

Preferably, the focal length of the fourth lens L4 is defined as f4, and the on-axis thickness of the fourth lens L4 is defined as d7. The following relationship formulas should be satisfied:

$$0.98 \leq f 4 / fA \leq 1 \text{.15} \qquad ( 16 )$$

$$0.041 \leq d 7 / TTL \leq 0.1 3. \qquad ( 17 )$$

The relationship formula (16) specifies the ratio range of the focal length f4 of the fourth lens L4 to the focal length fA of the imaging optical lenses 10, 20, 30, 40, 50, and 60 in the first state. Within the range defined by relationship (16), through reasonable distribution of refractive power, the system has better imaging quality and lower sensitivity.

The relationship formula (17) specifies the ratio range of the on-axis thickness d7 of the fourth lens L4 to the total optical length TTL of the imaging optical lenses 10, 20, 30, 40, 50, and 60. Within the range defined by relationship (17), it is beneficial to control the total optical length TTL of the imaging optical lenses 10, 20, 30, 40, 50, and 60, facilitating the miniaturized design of the imaging optical lenses 10, 20, 30, 40, 50, and 60.

An object-side surface of the fourth lens L4 is convex in a paraxial region, and an image-side surface of the fourth lens L4 is concave in a paraxial region. An object-side surface and an image-side surface of the fourth lens L4 may be configured with other concave and convex distributions.

Preferably, the imaging optical lenses 10, 20, 30, 40, 50, and 60 satisfy the following relationship:

$$0.25 \leq d 5 / d 7 \leq 1.15 . \qquad ( 18 )$$

The relationship formula (18) specifies the ratio range of the on-axis thickness d5 of the third lens L3 to the on-axis thickness d7 of the fourth lens L4. Within the range defined by relationship (18), the on-axis thicknesses of the third lens L3 and the fourth lens L4 may be reasonably distributed, thereby helping to reduce the assembly difficulty of the imaging optical lenses 10, 20, 30, 40, 50, and 60 in the actual production process and improving the yield of the imaging optical lenses 10, 20, 30, 40, 50, and 60. More preferably, 0.29≤d5/d7≤1.15.

Preferably, the focal length of the fifth lens L5 is defined as f5, the curvature radius of the object-side surface of the fifth lens L5 is defined as R9, the curvature radius of the image-side surface of the fifth lens L5 is defined as R10, and the on-axis thickness of the fifth lens L5 is defined as d9. The following relationship formulas should be satisfied:

$$- 1.93 \leq f 5 / fA \leq - 1.29 \qquad ( 19 )$$

$$4.31 \leq ( R 9 + R 10 ) / ( R 9 - R 10 ) \leq 6 \text{.33} \qquad ( 20 )$$

$$0.02 \leq d 9 / TTL \leq 0 \text{.04} . \qquad ( 21 )$$

The relationship formula (19) specifies the ratio range of the focal length f5 of the fifth lens L5 to the focal length fA of the imaging optical lenses 10, 20, 30, 40, 50, and 60 in the first state. Within the range defined by relationship (19), the light incident angle of the imaging optical lenses 10, 20, 30, 40, 50, and 60 is moderated, thereby reducing tolerance sensitivity.

The relationship formula (20) specifies the concave-convex shapes of the object-side surface and the image-side surface of the fifth lens L5. Within the range defined by relationship (20), as the imaging optical lenses 10, 20, 30, 40, 50, and 60 are miniaturized, it helps to correct aberrations of the off-axis field of view and other related issues.

The relationship formula (21) specifies the ratio range of the on-axis thickness d9 of the fifth lens L5 to the total optical length TTL of the imaging optical lenses 10, 20, 30, 40, 50, and 60. Within the range defined by relationship (21), it is beneficial to control the total optical length TTL of the imaging optical lenses 10, 20, 30, 40, 50, and 60, facilitating the miniaturized design of the imaging optical lenses 10, 20, 30, 40, 50, and 60. More preferably, 0.026≤d9/TTL≤0.032.

An object-side surface of the fifth lens L5 is convex in a paraxial region, and an image-side surface of the fifth lens L5 is concave in a paraxial region. An object-side surface and the image-side surface of the fifth lens L5 may be configured with other concave and convex distributions.

In the present disclosure, the first prism P1 is made of glass, and the first lens L1, the second lens L2, the third lens L3, the fourth lens L4, and the fifth lens L5 are made of plastic. In other alternative arrangements, the first prism P1 and each of the lenses may be made of other materials.

In the present disclosure, an optical filter GF and other optical elements are arranged between the fifth lens L5 and the imaging surface Si, where the optical filter GF can be a glass cover plate or an optical filter. In other alternative arrangements, the optical filter GF may be arranged at other positions.

In the present disclosure, an aperture ST may also be arranged between the first prism P1 and the first lens L1.

The imaging optical lenses 10, 20, 30, 40, 50, and 60 of the present disclosure will be described below with examples. The symbols recorded in each example are as shown in Table 1, and the units of focal length, on-axis distance, curvature radius, and on-axis thickness are millimeters.

TTL: Total optical length (the on-axis distance from the object-side surface of the first prism P1 to the imaging plane Si), in millimeters.

### First Embodiment

The first prism P1, has positive optical power, with its object-side surface being convex in the paraxial region and its image-side surface being convex in the paraxial region; The first lens, L1, has negative refractive power, with its object-side surface being convex in the paraxial region and its image-side surface being concave in the paraxial region; The second lens L2, has positive refractive power, with its object-side surface being convex in the paraxial region and its image-side surface being convex in the paraxial region; The third lens L3, has negative refractive power, with its object-side surface being concave in the paraxial region and its image-side surface being concave in the paraxial region; The fourth lens L4, has positive refractive power, with its object-side surface being convex in the paraxial region and its image-side surface being concave in the paraxial region; The fifth lens L5, has negative refractive power, with its object-side surface being convex in the paraxial region and its image-side surface being concave in the paraxial region.

FIG. 1A and FIG. 1B are schematic structural diagrams of the imaging optical lens 10 in the first embodiment. The following shows the design data of the imaging optical lens 10 in the first embodiment of the present disclosure.

Table 1 lists the curvature radius R of the object-side surface and image-side surface, the on-axis thickness of the lens, the on-axis distance d between lenses, the refractive index nd, and the Abbe number vd of the first prism P1 to the fifth lens L5 constituting the imaging optical lens 10 in the first embodiment of the present disclosure. It should be noted that in this embodiment, the units of distance, radius, and thickness are all millimeters (mm).

TABLE 1

| | R | d | | nd | | vd | |
|---|---|---|---|---|---|---|---|
| ST | ∞ | d0= | −9.530 | | | | |
| Rp1 | 17.906 | dp1= | 9.500 | nd1 | 1.8052 | vd1 | 40.89 |
| Rp2 | −124.069 | dp2= | dp2 | | | | |
| R1 | 6.075 | d1= | 0.879 | nd2 | 1.6400 | vd2 | 23.54 |
| R2 | 3.645 | d2= | 0.732 | | | | |
| R3 | 6.539 | d3= | 2.926 | nd3 | 1.5444 | vd3 | 55.82 |
| R4 | −7.062 | d4= | d4 | | | | |
| R5 | −6.311 | d5= | 2.188 | nd4 | 1.6153 | vd4 | 25.94 |
| R6 | 18.373 | d6= | 1.266 | | | | |
| R7 | 8.649 | d7= | 2.357 | nd5 | 1.6700 | vd5 | 19.39 |
| R8 | 37.474 | d8= | 1.852 | | | | |
| R9 | 5.086 | d9= | 0.687 | nd6 | 1.5346 | vd6 | 55.70 |
| R10 | 3.347 | d10= | 1.982 | | | | |
| R11 | ∞ | d11= | 0.210 | ndg | 1.5168 | vg | 64.17 |
| R12 | ∞ | d12= | 0.245 | | | | |

Herein, dp1=“dp1-01”+“dp1-02”, where “dp1-01”=4.9 and “dp1-02”=4.6.

Table 2 lists relevant optical parameters of the imaging optical lens 10 in the first embodiment of the present disclosure in the first state and the second state respectively.

TABLE 2

| | In the first state | In the second state |
|---|---|---|
| f | 16.287 | 14.489 |
| FOV | 24.23° | 23.73° |
| FNO | 2.27 | 2.60 |
| dp2 | 0.634 | 0.090 |
| d4 | 0.043 | 0.587 |

The meanings of the symbols in the above table are as follows:
R: the curvature radius of the optical surface, or the central curvature radius for lenses;
ST: aperture;
Rp1: the curvature radius of the object-side surface of the first prism P1;
Rp2: the curvature radius of the image-side surface of the first prism P1;
R1: the curvature radius of the object-side surface of the first lens L1;
R2: the curvature radius of the image-side surface of the first lens L1;
R3: the curvature radius of the object-side surface of the second lens L2;
R4: the curvature radius of the image-side surface of the second lens L2;
R5: the curvature radius of the object-side surface of the third lens L3;
R6: the curvature radius of the image-side surface of the third lens L3;
R7: the curvature radius of the object-side surface of the fourth lens L4;
R8: the curvature radius of the image-side surface of the fourth lens L4;
R9: the curvature radius of the object-side surface of the fifth lens L5;
R10: the curvature radius of the image-side surface of the fifth lens L5;
R11: the curvature radius of the object-side surface of the optical filter GF;
R12: the curvature radius of the image-side surface of the optical filter GF;
d: the on-axis thickness of the lens, or on-axis distance between lenses;
d0: the on-axis distance from the aperture ST to the object-side surface of the first prism P1;
dp1: the sum of the on-axis distance from the object-side surface of the first prism P1 to the reflective surface and the on-axis distance from the reflective surface to the image-side surface of the first prism P1;
dp1-01: the on-axis distance from the object-side surface of the first prism P1 to the reflective surface;
dp1-02: the on-axis distance from the reflective surface of the first prism P1 to the image-side surface;
dp2: the on-axis distance from the image-side surface of the first prism P1 to the object-side surface of the first lens L1;
d1: the on-axis thickness of the first lens L1;
d2: the on-axis distance from the image-side surface of the first lens L1 to the object-side surface of the second lens L2;
d3: the on-axis thickness of the second lens L2;
d4: the on-axis distance from the image-side surface of the second lens L2 to the object-side surface of the third lens L3;
d5: the on-axis thickness of the third lens L3;
d6: the on-axis distance from the image-side surface of the third lens L3 to the object-side surface of the fourth lens L4;
d7: the on-axis thickness of the fourth lens L4;
d8: the on-axis distance from the image-side surface of the fourth lens L4 to the object-side surface of the fifth lens L5;
d9: the on-axis thickness of the fifth lens L5;
d10: the on-axis distance from the image-side surface of the fifth lens L5 to the object-side surface of the optical filter GF;
d11: the on-axis thickness of the optical filter GF;
d12: the on-axis distance from the image-side surface of the optical filter GF to the imaging surface Si;
nd: the refractive index of d-line;
nd1: the refractive index of d-line of the first prism P1;
nd2: the refractive index of d-line of the first lens L1;
nd3: the refractive index of d-line of the second lens L2;
nd4: the refractive index of d-line of the third lens L3;
nd5: the refractive index of d-line of the fourth lens L4;
nd6: the refractive index of d-line of the fifth lens L5;
ndg: the refractive index of d-line of the optical filter GF;
vd: the Abbe number;
vd1: the Abbe number of the first prism P1;
vd2: the Abbe number of the first lens L1;
vd3: the Abbe number of the second lens L2;
vd4: the Abbe number of the third lens L3;
vd5: the Abbe number of the fourth lens L4;
vd6: the Abbe number of the fifth lens L5;
vg: the Abbe number of the optical filter GF.

Table 3 lists the conic coefficients k and aspherical coefficients of the imaging optical lens 10 in the first embodiment of the present disclosure.

TABLE 3

| | Conic | | | | | |
|---|---|---|---|---|---|---|
| | coefficient | Aspheric coefficient | | | | |
| | K | A4 | A6 | A8 | A10 | A12 |
| Rp1 | −3.29505E+00 | 1.11340E−04 | 4.65940E−07 | −2.53170E−07 | 4.30800E−08 | −4.10340E−09 |
| Rp2 | 0.00000E+00 | 0.00000E+00 | 0.00000E+00 | 0.00000E+00 | 0.00000E+00 | 0.00000E+00 |
| R1 | −4.87100E+00 | −3.77210E−03 | −6.65010E−05 | 7.75920E−05 | −4.43720E−05 | 1.91090E−05 |
| R2 | −7.19786E−01 | −8.88270E−03 | 8.94830E−05 | 6.65720E−05 | −2.53620E−05 | 8.77750E−06 |
| R3 | −1.45229E+01 | 4.30040E−03 | −1.08320E−03 | 2.20420E−04 | −5.08260E−05 | 1.07180E−05 |
| R4 | 8.00967E−01 | 3.88060E−04 | 1.08620E−05 | −8.06720E−06 | −9.38370E−07 | 7.87480E−07 |
| R5 | −2.63368E+01 | −9.22410E−03 | 3.60340E−03 | −1.18810E−03 | 3.15600E−04 | −6.25180E−05 |
| R6 | 1.64728E+01 | −1.29740E−03 | 2.28160E−04 | −2.12530E−04 | 2.31900E−04 | −1.82440E−04 |
| R7 | −9.79209E+00 | −3.07520E−03 | 1.72800E−04 | 3.75490E−05 | −1.09760E−04 | 8.73190E−05 |
| R8 | 1.74382E+01 | −5.90310E−03 | 6.42270E−04 | 8.85130E−05 | −2.64380E−04 | 2.01830E−04 |
| R9 | −9.29572E−01 | −3.10490E−02 | 2.37940E−03 | −2.84700E−03 | 3.54150E−03 | −2.43380E−03 |
| R10 | −1.06401E+01 | 3.74840E−05 | −1.05080E−02 | 5.68320E−03 | −2.11530E−03 | 5.82310E−04 |

| | Conic | | | | | |
|---|---|---|---|---|---|---|
| | coefficient | Aspheric coefficient | | | | |
| | K | A14 | A16 | A18 | A20 | A22 |
| Rp1 | −3.29505E+00 | 2.35850E−10 | −8.04590E−12 | 1.49570E−13 | −1.16480E−15 | 0.00000E+00 |
| Rp2 | 0.00000E+00 | 0.00000E+00 | 0.00000E+00 | 0.00000E+00 | 0.00000E+00 | 0.00000E+00 |
| R1 | −4.87100E+00 | −5.34680E−06 | 9.45940E−07 | −1.02160E−07 | 6.14040E−09 | −1.57269E−10 |
| R2 | −7.19786E−01 | −2.30000E−06 | 4.18860E−07 | −4.89560E−08 | 3.28440E−09 | −9.60291E−11 |
| R3 | −1.45229E+01 | −1.65880E−06 | 1.69640E−07 | −9.91560E−09 | 2.45720E−10 | 0.00000E+00 |
| R4 | 8.00967E−01 | −1.33070E−07 | 9.84660E−09 | −2.47180E−10 | −2.64560E−12 | 0.00000E+00 |
| R5 | −2.63368E+01 | 8.70520E−06 | −7.97210E−07 | 4.27640E−08 | −1.01180E−09 | 0.00000E+00 |
| R6 | 1.64728E+01 | 9.40040E−05 | −3.27130E−05 | 7.85930E−06 | −1.30780E−06 | 1.48078E−07 |
| R7 | −9.79209E+00 | −4.39720E−05 | 1.52910E−05 | −3.73490E−06 | 6.37450E−07 | −7.42706E−08 |
| R8 | 1.74382E+01 | −9.29610E−05 | 2.86000E−05 | −6.05520E−06 | 8.85540E−07 | −8.79057E−08 |
| R9 | −9.29572E−01 | 1.06500E−03 | −3.15190E−04 | 6.45980E−05 | −9.18620E−06 | 8.89806E−07 |
| R10 | −1.06401E+01 | −1.17870E−04 | 1.72400E−05 | −1.77590E−06 | 1.23380E−07 | −5.29647E−09 |

| | Conic | | | |
|---|---|---|---|---|
| | coefficient | Aspheric coefficient | | |
| | K | A24 | A26 | A28 |
| Rp1 | −3.29505E+00 | 0.00000E+00 | 0.00000E+00 | 0.00000E+00 |
| Rp2 | 0.00000E+00 | 0.00000E+00 | 0.00000E+00 | 0.00000E+00 |
| R1 | −4.87100E+00 | 0.00000E+00 | 0.00000E+00 | 0.00000E+00 |
| R2 | −7.19786E−01 | 0.00000E+00 | 0.00000E+00 | 0.00000E+00 |
| R3 | −1.45229E+01 | 0.00000E+00 | 0.00000E+00 | 0.00000E+00 |
| R4 | 8.00967E−01 | 0.00000E+00 | 0.00000E+00 | 0.00000E+00 |
| R5 | −2.63368E+01 | 0.00000E+00 | 0.00000E+00 | 0.00000E+00 |
| R6 | 1.64728E+01 | −1.08856E−08 | 4.68486E−10 | −8.95895E−12 |
| R7 | −9.79209E+00 | 5.61685E−09 | −2.48029E−10 | 4.84642E−12 |
| R8 | 1.74382E+01 | 5.65412E−09 | −2.12504E−10 | 3.54202E−12 |
| R9 | −9.29572E−01 | −5.60105E−08 | 2.06549E−09 | −3.38578E−11 |
| R10 | −1.06401E+01 | 1.10091E−10 | 2.14509E−13 | −3.73876E−14 |

It should be note that the asp erica surfaces of each lens in an embodiment are defined by the following relationship formula (22). However, the specific form of the following relationship formula (22) is only an example. The present disclosure is not limited to the aspherical polynomial form identified in relationship (22).

$$z = ( {c}^{2} / r ) / \{ 1 + {[ 1 - ( k + 1 ) ( {c}^{2} / {r}^{2} ) ]}^{1 / 2} \} + {A 4 c}^{4} + A 6 {c}^{6} + A 8 {c}^{8} + A 10 {c}^{10} + A 12 {c}^{12} + {A 14 c}^{14} + A 16 {c}^{16} + A 18 {c}^{18} + A 20 {c}^{20} + A 22 {c}^{22} + {A 24 c}^{24} + A 26 {c}^{26} + A 28 {c}^{28} \qquad ( 22 )$$

Herein, k is the conic coefficient; A4, A6, A8, A10, A12, A14, A16, A18, A20, A22, A24, A26, A28 are aspherical coefficients; c is the curvature at the center of the optical surface; r is the vertical distance from a point on the aspherical curve to the optical axis; z is the aspherical depth (the vertical distance between a point on the aspherical surface at a distance r from the optical axis and the tangent plane at the vertex of the aspherical surface on the optical axis).

In addition, in the subsequent Table 19, the values corresponding to the parameters specified in the relationship formulas and various parameters in the first embodiment are also listed.

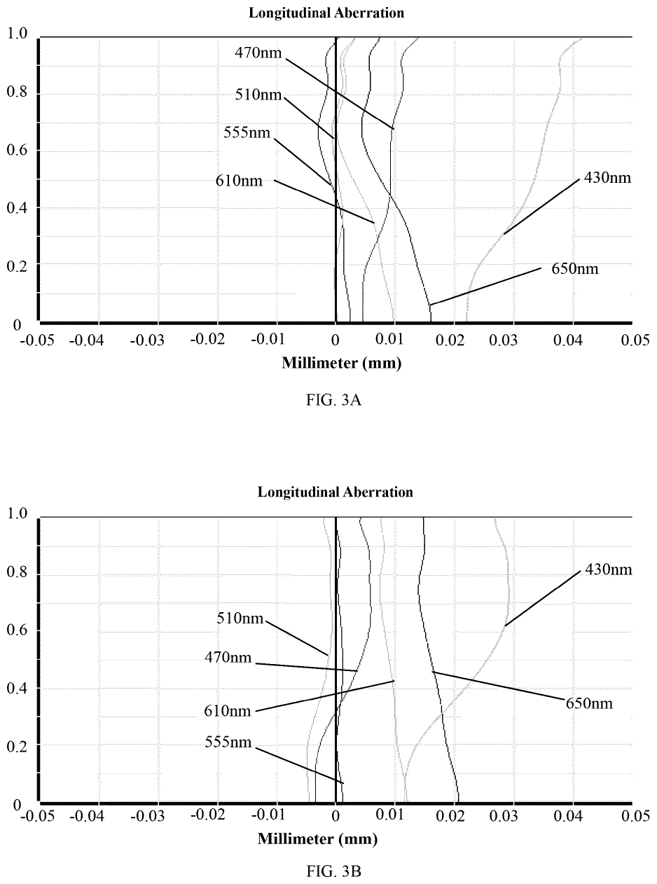

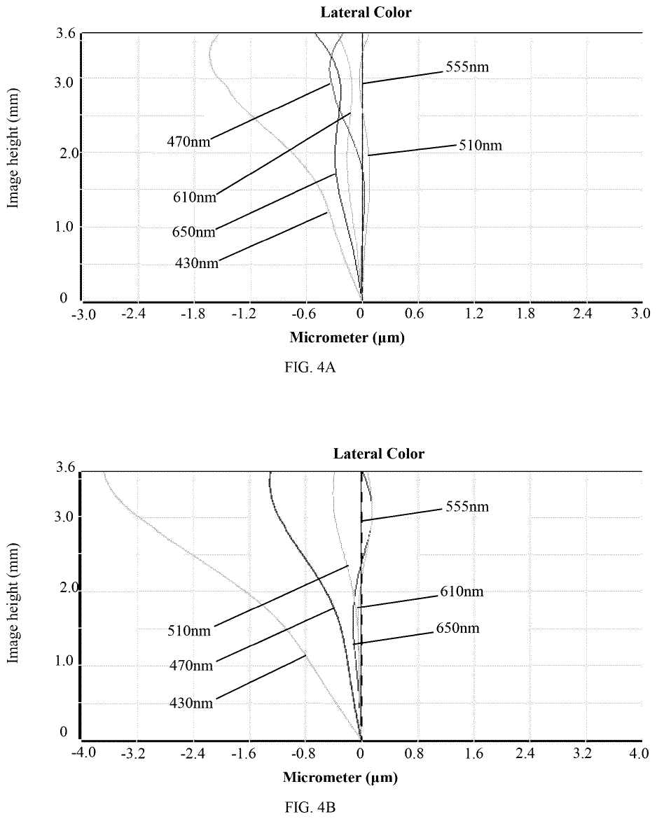

FIG. 2A and FIG. 2B show schematic diagrams of the field curvature and distortion of light with a wavelength of 555 nm after passing through the imaging optical lens 10 of the first embodiment. FIG. 3A and FIG. 3B show schematic diagrams of the longitudinal aberration of light with wavelengths of 430 nm, 470 nm, 510 nm, 555 nm, 610 nm, and 650 nm after passing through the imaging optical lens 10 of the first embodiment. FIG. 4A and FIG. 4B show schematic diagrams of the lateral color of light with wavelengths of 430 nm, 470 nm, 510 nm, 555 nm, 610 nm, and 650 nm after passing through the imaging optical lens 10 of the first embodiment.

As shown in Table 19, the first embodiment satisfies all the relationship formulas.

In an embodiment, the pupil entering diameter (ENPD) of the imaging optical lens 10 in the first state is 7.162 mm, the full-field image height is 3.600 mm, and the diagonal field of view is 24.23°. The imaging optical lens 10 has the characteristics of a large aperture, telephoto, and miniaturization, with its on-axis and off-axis chromatic aberrations fully corrected, and excellent optical performance.

### Second Embodiment

The first prism P1, has positive refractive power, with its object-side surface being convex in the paraxial region and its image-side surface being convex in the paraxial region;
the first lens L1, has negative refractive power, with its object-side surface being convex in the paraxial region and its image-side surface being concave in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface being concave in the paraxial region;
the fourth lens L4, has positive refractive power, with its object-side surface being convex in the paraxial region and its image-side surface being concave in the paraxial region; and
the fifth lens L5, has negative refractive power, with its object-side surface being convex in the paraxial region and its image-side surface being concave in the paraxial region.

FIG. 5A and FIG. 5B are schematic structural diagrams of the imaging optical lens 20 in the second embodiment. The second embodiment is basically the same as the first embodiment, with the same symbol meanings as the first embodiment, and only the differences are listed below.

Tables 4-6 show the design data of the imaging optical lens 20 in the second embodiment of the present disclosure.

TABLE 4

| | R | d | | nd | | vd | |
|---|---|---|---|---|---|---|---|
| ST | ∞ | d0= | −9.530 | | | | |
| Rp1 | 22.164 | dp1= | 9.500 | nd1 | 1.8052 | vd1 | 40.89 |
| Rp2 | −34.260 | dp2= | dp2 | | | | |
| R1 | 7.037 | d1= | 1.535 | nd2 | 1.6400 | vd2 | 23.54 |
| R2 | 3.822 | d2= | 0.914 | | | | |
| R3 | 6.388 | d3= | 1.280 | nd3 | 1.5444 | vd3 | 55.82 |
| R4 | −7.711 | d4= | d4 | | | | |
| R5 | −6.270 | d5= | 2.397 | nd4 | 1.6153 | vd4 | 25.94 |
| R6 | 18.775 | d6= | 1.122 | | | | |
| R7 | 8.474 | d7= | 2.501 | nd5 | 1.6700 | vd5 | 19.39 |
| R8 | 25.422 | d8= | 1.996 | | | | |
| R9 | 5.232 | d9= | 0.689 | nd6 | 1.5346 | vd6 | 55.70 |
| R10 | 3.680 | d10= | 2.195 | | | | |
| R11 | ∞ | d11= | 0.210 | ndg | 1.5168 | νg | 64.17 |
| R12 | ∞ | d12= | 0.351 | | | | |

Herein, dp11=“dp1-01”+“dp1-02”, “dp1-01”=4.9, “dp1-02”=4.6.

Table 5 lists relevant optical parameters of the imaging optical lens 20 in the second embodiment of the present disclosure in the first state and the second state respectively.

TABLE 5

| | In the first state | In the second state |
|---|---|---|
| f | 16.025 | 14.399 |
| FOV | 24.77° | 24.30° |
| FNO | 2.26 | 2.55 |
| dp2 | 0.656 | 0.145 |
| d4 | 0.061 | 0.572 |

Table 6 lists the conic coefficients k and aspherical coefficients of the imaging optical lens 20 in the second embodiment of the present disclosure.

TABLE 6

| | Conic | | | | | |
|---|---|---|---|---|---|---|
| | coefficient | Aspheric coefficient | | | | |
| | K | A4 | A6 | A8 | A10 | A12 |
| Rp1 | −4.30387E+00 | 8.90500E−05 | −6.48200E−07 | −1.62910E−08 | 7.39930E−09 | −1.46620E−09 |
| Rp2 | 0.00000E+00 | 0.00000E+00 | 0.00000E+00 | 0.00000E+00 | 0.00000E+00 | 0.00000E+00 |
| R1 | −3.87039E+00 | −2.90790E−03 | −1.35160E−04 | 6.62080E−05 | −3.39960E−05 | 1.21960E−05 |
| R2 | −7.01735E−01 | −7.65860E−03 | −2.81360E−04 | 1.96640E−04 | −9.00160E−05 | 3.22360E−05 |
| R3 | −1.67726E+01 | 5.26940E−03 | −1.88300E−03 | 4.89560E−04 | −1.28180E−04 | 2.91310E−05 |
| R4 | 1.15259E+00 | 5.02300E−04 | −5.80330E−04 | 3.00670E−04 | −1.03910E−04 | 2.56190E−05 |
| R5 | −2.64903E+01 | −9.17820E−03 | 3.38170E−03 | −9.88320E−04 | 2.34010E−04 | −4.20680E−05 |
| R6 | 1.57982E+01 | −2.05070E−03 | −4.79790E−05 | 8.12930E−04 | −8.68680E−04 | 5.53500E−04 |
| R7 | −1.29459E+01 | −3.79910E−03 | −1.45030E−05 | 3.86640E−04 | −3.33640E−04 | 1.80990E−04 |
| R8 | −3.76715E+01 | −6.91320E−03 | 1.01490E−03 | −4.29230E−04 | 3.20060E−04 | −1.90110E−04 |
| R9 | −6.88632E−01 | −2.97410E−02 | 9.67540E−04 | 1.38020E−04 | 8.79360E−05 | −8.45380E−05 |
| R10 | −1.09448E+01 | −4.37360E−03 | −7.47450E−03 | 4.09610E−03 | −1.50500E−03 | 4.22180E−04 |

| | Conic | | | | | |
|---|---|---|---|---|---|---|
| | coefficient | Aspheric coefficient | | | | |
| | K | A14 | A16 | A18 | A20 | A22 |
| Rp1 | −4.30387E+00 | 1.60540E−10 | −9.41080E−12 | 2.80380E−13 | −3.35000E−15 | 0.0000E+00 |
| Rp2 | 0.00000E+00 | 0.00000E+00 | 0.00000E+00 | 0.00000E+00 | 0.00000E+00 | 0.0000E+00 |
| R1 | −3.87039E+00 | −2.82010E−06 | 4.12740E−07 | −3.67000E−08 | 1.78930E−09 | −3.6149E−11 |
| R2 | −7.01735E−01 | −7.78950E−06 | 1.22860E−06 | −1.21440E−07 | 6.77650E−09 | −1.6141E−10 |
| R3 | −1.67726E+01 | −4.67560E−06 | 4.84500E−07 | −2.92660E−08 | 7.74740E−10 | 0.0000E+00 |
| R4 | 1.15259E+00 | −4.23280E−06 | 4.45940E−07 | −2.69950E−08 | 7.04840E−10 | 0.0000E+00 |
| R5 | −2.64903E+01 | 5.32600E−06 | −4.36940E−07 | 2.05190E−08 | −4.15010E−10 | 0.0000E+00 |
| R6 | 1.57982E+01 | −2.39700E−04 | 7.27340E−05 | −1.55940E−05 | 2.34920E−06 | −2.4319E−07 |
| R7 | −1.29459E+01 | −7.21750E−05 | 2.18120E−05 | −4.97110E−06 | 8.33450E−07 | −9.8762E−08 |
| R8 | −3.76715E+01 | 7.66760E−05 | −2.11660E−05 | 4.05430E−06 | −5.38920E−07 | 4.8788E−08 |
| R9 | −6.88632E−01 | 4.14260E−05 | −1.48550E−05 | 3.83600E−06 | −6.82240E−07 | 8.0594E−08 |
| R10 | −1.09448E+01 | −9.00440E−05 | 1.42300E−05 | −1.61460E−06 | 1.26230E−07 | −6.3635E−09 |

| | Conic | | | |
|---|---|---|---|---|
| | coefficient | Aspheric coefficient | | |
| | K | A24 | A26 | A28 |
| Rp1 | −4.30387E+00 | 0.0000E+00 | 0.0000E+00 | 0.0000E+00 |
| Rp2 | 0.00000E+00 | 0.0000E+00 | 0.0000E+00 | 0.0000E+00 |
| R1 | −3.87039E+00 | 0.00000E+00 | 0.00000E+00 | 0.00000E+00 |
| R2 | −7.01735E−01 | 0.00000E+00 | 0.00000E+00 | 0.00000E+00 |
| R3 | −1.67726E+01 | 0.0000E+00 | 0.0000E+00 | 0.0000E+00 |
| R4 | 1.15259E+00 | 0.0000E+00 | 0.0000E+00 | 0.0000E+00 |
| R5 | −2.64903E+01 | 0.0000E+00 | 0.0000E+00 | 0.0000E+00 |
| R6 | 1.57982E+01 | 1.6467E−08 | −6.5653E−10 | 1.1685E−11 |
| R7 | −1.29459E+01 | 7.7697E−09 | −3.6222E−10 | 7.5480E−12 |
| R8 | −3.76715E+01 | −2.8703E−09 | 9.8967E−11 | −1.5177E−12 |
| R9 | −6.88632E−01 | −6.0165E−09 | 2.5645E−10 | −4.7504E−12 |
| R10 | −1.09448E+01 | 1.8044E−10 | −1.8457E−12 | −1.4873E−14 |

In addition, in the subsequent Table 19, the values corresponding to the parameters specified in the relationship formulas in the second embodiment are also listed.

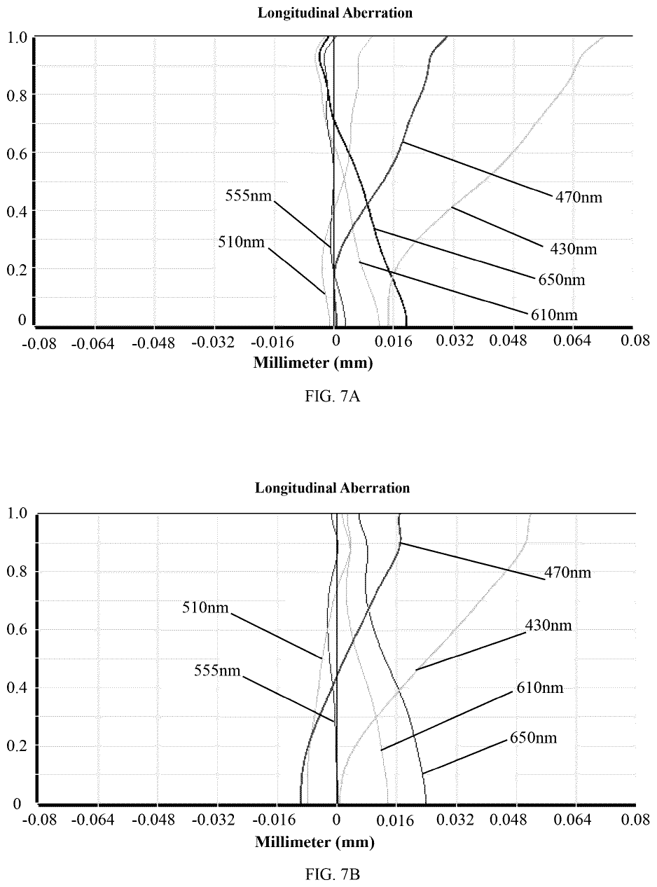

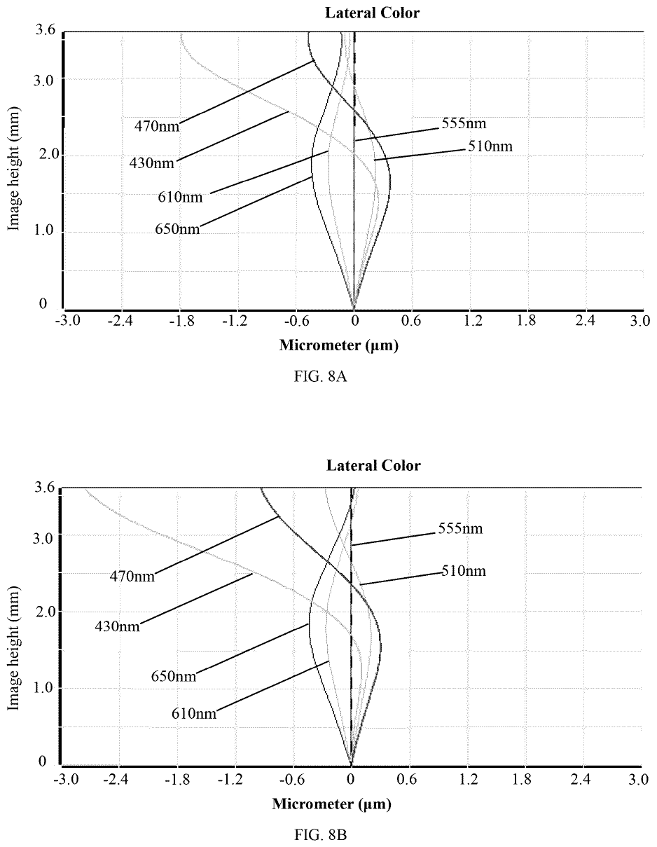

FIG. 6A and FIG. 6B show schematic diagrams of the field curvature and distortion of light with a wavelength of 555 nm after passing through the imaging optical lens 20 of the second embodiment. FIG. 7A and FIG. 7B show schematic diagrams of the longitudinal aberration of light with wavelengths of 430 nm, 470 nm, 510 nm, 555 nm, 610 nm, and 650 nm after passing through the imaging optical lens 20 of the second embodiment. FIG. 8A and FIG. 8B show schematic diagrams of the lateral color of light with wavelengths of 430 nm, 470 nm, 510 nm, 555 nm, 610 nm, and 650 nm after passing through the imaging optical lens 20 of the second embodiment.

As shown in Table 19, the second embodiment satisfies all the relationship formulas.

In an embodiment, the entrance pupil diameter of the imaging optical lens 20 in the first state is 7.089 mm, the full-field image height is 3.600 mm, and the diagonal field of view is 24.770. The imaging optical lens 20 has the characteristics of a large aperture, long focal length, and miniaturization. Its on-axis and off-axis chromatic aberrations are fully corrected, and it has excellent optical performance.

### Third Embodiment

The first prism P1 has positive refractive power, with its object-side surface being convex in the paraxial region and its image-side surface being convex in the paraxial region;
the first lens L1, has negative refractive power, with its object-side surface being convex in the paraxial region and its image-side surface being concave in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface being concave in the paraxial region;
the fourth lens L4, has positive refractive power, with its object-side surface being convex in the paraxial region and its image-side surface being concave in the paraxial region;
the fifth lens L5, has negative refractive power, with its object-side surface being convex in the paraxial region and its image-side surface being concave in the paraxial region.

FIG. 9A and FIG. 9B are schematic structural diagrams of the imaging optical lens 30 in the third embodiment. The third embodiment is substantially the same as the first embodiment, with the same symbol meanings as the first embodiment, and only differences are listed below.

Tables 7-9 show the design data of the imaging optical lens 30 in the third embodiment of the present disclosure.

TABLE 7

| | R | d | | nd | | vd | |
|---|---|---|---|---|---|---|---|
| ST | ∞ | d0= | −9.530 | | | | |
| Rp1 | 26.347 | dp1= | 9.500 | nd1 | 1.8052 | vd1 | 40.89 |
| Rp2 | −23.329 | dp2= | dp2 | | | | |
| R1 | 7.033 | d1= | 1.300 | nd2 | 1.6400 | vd2 | 23.54 |
| R2 | 3.786 | d2= | 0.745 | | | | |
| R3 | 6.591 | d3= | 1.858 | nd3 | 1.5444 | vd3 | 55.82 |
| R4 | −7.621 | d4= | d4 | | | | |
| R5 | −6.528 | d5= | 1.988 | nd4 | 1.6153 | vd4 | 25.94 |
| R6 | 17.116 | d6= | 1.460 | | | | |
| R7 | 9.895 | d7= | 1.739 | nd5 | 1.6700 | vd5 | 19.39 |
| R8 | 108.850 | d8= | 2.212 | | | | |
| R9 | 6.071 | d9= | 0.811 | nd6 | 1.5346 | vd6 | 55.70 |
| R10 | 3.787 | d10= | 2.360 | | | | |
| R11 | ∞ | d11= | 0.210 | ndg | 1.5168 | νg | 64.17 |
| R12 | ∞ | d12= | 0.434 | | | | |

Herein, dp11=“dp1-01”+“dp1-02”, “dp1-01”=4.9, “dp1-02”=4.6.

Table 8 lists relevant optical parameters of the imaging optical lens 30 in the third embodiment in the first state and the second state respectively.

TABLE 8

| | In the first state | In the second state |
|---|---|---|
| f | 16.000 | 14.400 |
| FOV | 24.64° | 24.25° |
| FNO | 2.28 | 2.56 |
| dp2 | 0.851 | 0.335 |
| d4 | 0.032 | 0.547 |

Table 9 lists the conic coefficients and aspherical coefficients of the imaging optical lens 30 in the third embodiment of the present disclosure.

TABLE 9

| | Conic | | | | | |
|---|---|---|---|---|---|---|
| | coefficient | Aspheric coefficient | | | | |
| | K | A4 | A6 | A8 | A10 | A12 |
| Rp1 | −5.82811E+00 | 5.43110E−05 | −7.39670E−07 | 2.37610E−08 | 6.67650E−10 | −5.71150E−10 |
| Rp2 | 0.00000E+00 | 0.00000E+00 | 0.00000E+00 | 0.00000E+00 | 0.00000E+00 | 0.00000E+00 |
| R1 | −4.08537E+00 | −3.15650E−03 | −8.47360E−05 | 3.16010E−05 | −1.19210E−05 | 3.80610E−06 |
| R2 | −6.64265E−01 | −7.48530E−03 | −2.25600E−04 | 1.21230E−04 | −4.79100E−05 | 1.60390E−05 |
| R3 | −1.55150E+01 | 4.45920E−03 | −1.30900E−03 | 2.55840E−04 | −5.30900E−05 | 1.00470E−05 |
| R4 | 9.11143E−01 | 2.21380E−04 | −1.50720E−04 | 7.17230E−05 | −2.54020E−05 | 6.40840E−06 |
| R5 | −2.53862E+01 | −8.44850E−03 | 2.89140E−03 | −8.20690E−04 | 1.89760E−04 | −3.29500E−05 |
| R6 | 1.52231E+01 | −2.48480E−03 | 4.49220E−04 | −9.63470E−06 | −4.67340E−05 | 2.35550E−05 |
| R7 | −1.37449E+01 | −4.64150E−03 | 5.86340E−04 | −2.70940E−04 | 2.73050E−04 | −1.98890E−04 |
| R8 | 0.00000E+00 | −6.87960E−03 | 9.30810E−04 | −1.16330E−04 | −1.18750E−05 | 2.15920E−05 |
| R9 | −4.92636E−01 | −2.81260E−02 | 1.79580E−03 | −9.22080E−04 | 1.03390E−03 | −6.62140E−04 |
| R10 | −9.88607E+00 | −7.85900E−03 | −4.13030E−03 | 2.45710E−03 | −9.26440E−04 | 2.73500E−04 |

| | Conic | | | | | |
|---|---|---|---|---|---|---|
| | coefficient | Aspheric coefficient | | | | |
| | K | A14 | A16 | A18 | A20 | A22 |
| Rp1 | −5.82811E+00 | 8.05730E−11 | −5.29690E−12 | 1.70500E−13 | −2.17120E−15 | 0.0000E+00 |
| Rp2 | 0.00000E+00 | 0.00000E+00 | 0.00000E+00 | 0.00000E+00 | 0.00000E+00 | 0.0000E+00 |
| R1 | −4.08537E+00 | −8.03200E−07 | 1.07550E−07 | −8.72990E−09 | 3.86290E−10 | −7.0622E−12 |
| R2 | −6.64265E−01 | −3.56960E−06 | 5.18710E−07 | −4.71370E−08 | 2.40600E−09 | −5.2507E−11 |
| R3 | −1.55150E+01 | −1.33110E−06 | 1.17210E−07 | −6.17410E−09 | 1.43130E−10 | 0.0000E+00 |
| R4 | 9.11143E−01 | −1.02710E−06 | 1.01980E−07 | −5.60820E−09 | 1.29100E−10 | 0.0000E+00 |
| R5 | −2.53862E+01 | 3.99310E−06 | −3.12720E−07 | 1.39830E−08 | −2.66440E−10 | 0.0000E+00 |
| R6 | 1.52231E+01 | −6.81360E−06 | 1.31450E−06 | −1.71110E−07 | 1.39960E−08 | −5.5991E−10 |
| R7 | −1.37449E+01 | 9.50560E−05 | −3.06830E−05 | 6.82190E−06 | −1.04690E−06 | 1.0887E−07 |
| R8 | 0.00000E+00 | −1.09900E−05 | 3.51100E−06 | −7.68470E−07 | 1.16670E−07 | −1.2092E−08 |
| R9 | −4.92636E−01 | 2.77780E−04 | −8.10550E−05 | 1.67240E−05 | −2.42880E−06 | 2.4244E−07 |
| R10 | −9.88607E+00 | −6.39440E−05 | 1.15540E−05 | −1.56760E−06 | 1.55050E−07 | −1.0771E−08 |

| | Conic | | | |
|---|---|---|---|---|
| | coefficient | Aspheric coefficient | | |
| | K | A24 | A26 | A28 |
| Rp1 | −5.82811E+00 | 0.0000E+00 | 0.0000E+00 | 0.0000E+00 |
| Rp2 | 0.00000E+00 | 0.0000E+00 | 0.0000E+00 | 0.0000E+00 |
| R1 | −4.08537E+00 | 0.0000E+00 | 0.0000E+00 | 0.0000E+00 |
| R2 | −6.64265E−01 | 0.0000E+00 | 0.0000E+00 | 0.0000E+00 |
| R3 | −1.55150E+01 | 0.0000E+00 | 0.0000E+00 | 0.0000E+00 |
| R4 | 9.11143E−01 | 0.0000E+00 | 0.0000E+00 | 0.0000E+00 |
| R5 | −2.53862E+01 | 0.0000E+00 | 0.0000E+00 | 0.0000E+00 |
| R6 | 1.52231E+01 | −6.5347E−12 | 1.5561E−12 | −4.3308E−14 |
| R7 | −1.37449E+01 | −7.3179E−09 | 2.8644E−10 | −4.9471E−12 |
| R8 | 0.00000E+00 | 8.1634E−10 | −3.2335E−11 | 5.7021E−13 |
| R9 | −4.92636E−01 | −1.5804E−08 | 6.0445E−10 | −1.0261E−11 |
| R10 | −9.88607E+00 | 4.9610E−10 | −1.3576E−11 | 1.6702E−13 |

In addition, in the subsequent Table 19, the values corresponding to the parameters specified in the relationship formulas and various parameters in the third embodiment are also listed.

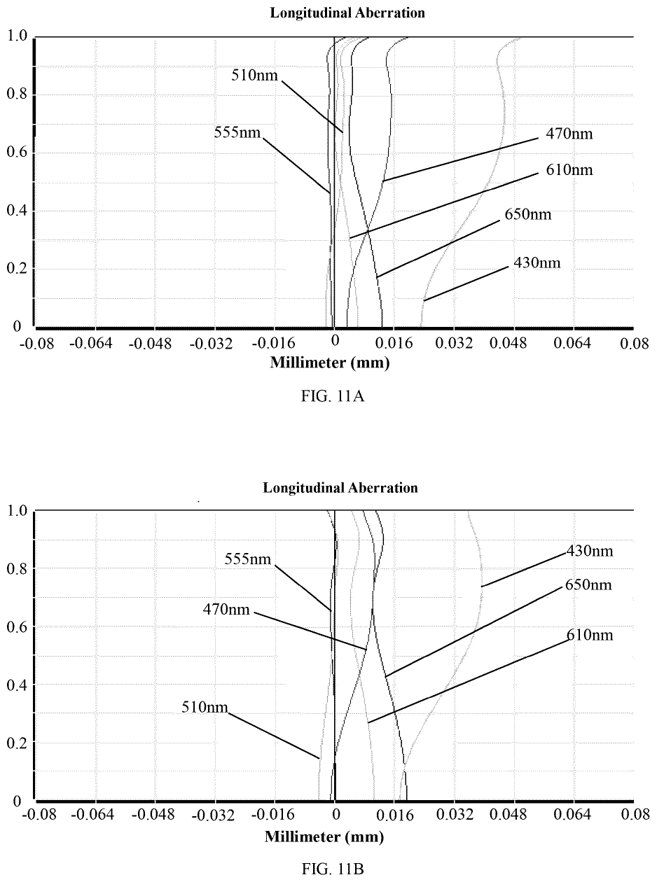

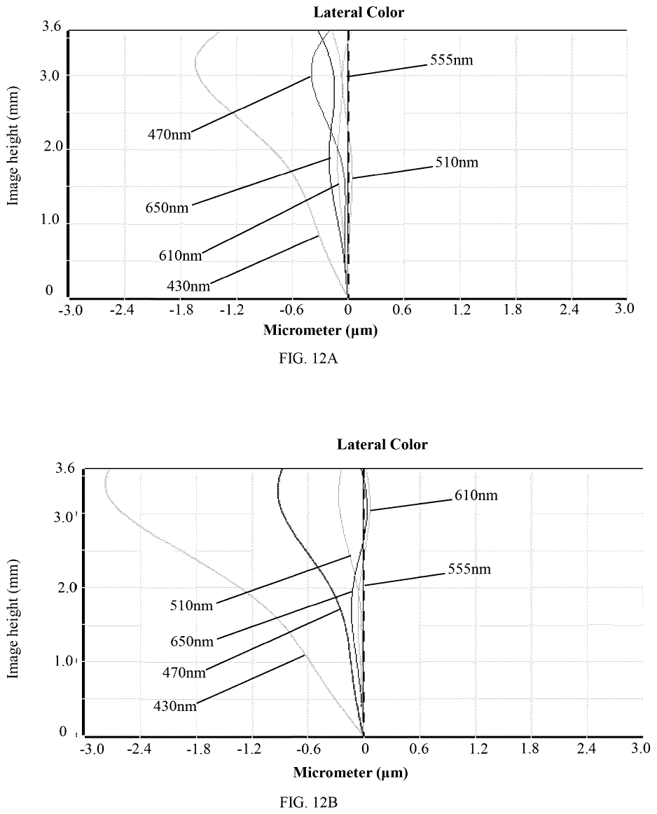

FIG. 10A and FIG. 10B show schematic diagrams of the field curvature and distortion of light with of 555 nm after passing through the imaging optical lens 30 of the third embodiment. FIG. 11A and FIG. 11B show schematic diagrams of the longitudinal aberration of light with wavelengths of 430 nm, 470 nm, 510 nm, 555 nm, 610 nm, and 650 nm after passing through the imaging optical lens 30 of the third embodiment. FIG. 12A and FIG. 12B show schematic diagrams of the lateral color of light with wavelengths of 430 nm, 470 nm, 510 nm, 555 nm, 610 nm, and 650 nm after passing through the imaging optical lens 30 of the third embodiment.

As shown in Table 19, the third embodiment satisfies all the relationship formulas.

In an embodiment, the entrance pupil diameter of the imaging optical lens 30 in the first state is 7.009 mm, the full-field image height is 3.600 mm, and the diagonal field of view is 24.64°. The imaging optical lens 30 has the characteristics of a large aperture, long focal length, and miniaturization, with its on-axis and off-axis chromatic aberrations are fully corrected, and excellent optical performance.

### Fourth Embodiment

The first prism P1, has positive refractive power, with its object-side surface being convex in the paraxial region and its image-side surface being convex in the paraxial region;
the first lens L1, has negative refractive power, with its object-side surface being convex in the paraxial region and its image-side surface being concave in the paraxial region;
the second lens L2, has positive refractive power, with its object-side surface being convex in the paraxial region and its image-side surface being convex in the paraxial region;
the third lens, L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being concave in the paraxial region; and
the fifth lens L5, has negative refractive power, with its object-side surface being convex in the paraxial region and its image-side surface being concave in the paraxial region.

FIG. 13A and FIG. 13B are schematic diagrams showing the structure of the imaging optical lens 40 in the fourth embodiment. The fourth embodiment is basically the same as the first embodiment, and the meanings of the symbols are the same as those in the first embodiment. Only the differences are listed below.

Tables 10-12 show the design data of the imaging optical lens 40 according to the fourth embodiment of the present invention.

TABLE 10

| | R | d | | nd | | vd | |
|---|---|---|---|---|---|---|---|
| ST | ∞ | d0= | −9.530 | | | | |
| Rp1 | 28.344 | dp1= | 9.500 | nd1 | 1.8052 | vd1 | 40.89 |
| Rp2 | −21.832 | dp2= | dp2 | | | | |
| R1 | 6.850 | d1= | 1.252 | nd2 | 1.6400 | vd2 | 23.54 |
| R2 | 3.802 | d2= | 0.739 | | | | |
| R3 | 6.933 | d3= | 2.213 | nd3 | 1.5444 | vd3 | 55.82 |
| R4 | −7.653 | d4= | d4 | | | | |
| R5 | −5.945 | d5= | 0.783 | nd4 | 1.6153 | vd4 | 25.94 |
| R6 | 21.745 | d6= | 1.844 | | | | |
| R7 | 7.749 | d7= | 2.622 | nd5 | 1.6700 | vd5 | 19.39 |
| R8 | 18.820 | d8= | 1.742 | | | | |
| R9 | 4.941 | d9= | 0.704 | nd6 | 1.5346 | vd6 | 55.70 |
| R10 | 3.583 | d10= | 2.596 | | | | |
| R11 | ∞ | d11= | 0.210 | ndg | 1.5168 | νg | 64.17 |
| R12 | ∞ | d12= | 0.519 | | | | |

Herein, dp11=“dp1-01”+“dp1-02”, “dp1-01”=4.9, “dp1-02”=4.6.

Table 11 lists relevant optical parameters of the imaging optical lens 40 in the fourth embodiment of the present disclosure in the first state and the second state respectively.

TABLE 11

| | In the first state | In the second state |
|---|---|---|
| f | 15.941 | 14.4 |
| FOV | 24.85° | 24.45° |
| FNO | 2.27 | 2.53 |
| dp2 | 0.68 | 0.163 |
| d4 | 0.094 | 0.611 |

Table 12 lists the conic coefficients k and aspherical coefficients of the imaging optical lens 40 in the fourth embodiment of the present disclosure.

TABLE 12

| | Conic | | | | | |
|---|---|---|---|---|---|---|
| | coefficient | Aspheric coefficient | | | | |
| | K | A4 | A6 | A8 | A10 | A12 |
| Rp1 | −7.24243E+00 | 4.55790E−05 | −5.92580E−07 | −4.97560E−08 | 1.61580E−08 | −2.45410E−09 |
| Rp2 | 0.00000E+00 | 0.00000E+00 | 0.00000E+00 | 0.00000E+00 | 0.00000E+00 | 0.00000E+00 |
| R1 | −4.03332E+00 | −3.06400E−03 | −1.06990E−04 | 3.92950E−05 | −1.60670E−05 | 5.53290E−06 |
| R2 | −6.79743E−01 | −7.27870E−03 | −2.55110E−04 | 9.60810E−05 | −2.83520E−05 | 8.04580E−06 |
| R3 | −1.63988E+01 | 4.11340E−03 | −1.18080E−03 | 2.03530E−04 | −3.31470E−05 | 4.35170E−06 |
| R4 | 9.14570E−01 | 2.70370E−04 | −1.26760E−04 | 6.60430E−05 | −2.24490E−05 | 5.14300E−06 |
| R5 | −2.43026E+01 | −1.13440E−02 | 4.66890E−03 | −1.44220E−03 | 3.37720E−04 | −5.73490E−05 |
| R6 | 2.81020E+01 | −2.95670E−03 | 9.40260E−04 | −6.49610E−05 | −1.08420E−04 | 6.31050E−05 |
| R7 | −6.04916E+00 | −3.34180E−03 | 5.71010E−04 | −2.43380E−04 | 1.79740E−04 | −1.10430E−04 |
| R8 | 1.58703E+01 | −6.97940E−03 | 1.41090E−03 | −5.00950E−04 | 2.31260E−04 | −9.17200E−05 |
| R9 | −5.29380E−01 | −3.38940E−02 | 2.97420E−03 | −1.53700E−03 | 1.37770E−03 | −7.76830E−04 |
| R10 | −9.17634E+00 | −1.13860E−02 | −3.39480E−03 | 2.10110E−03 | −7.32980E−04 | 2.14050E−04 |

| | Conic | | | | | |
|---|---|---|---|---|---|---|
| | coefficient | Aspheric coefficient | | | | |
| | K | A14 | A16 | A18 | A20 | A22 |
| Rp1 | −7.24243E+00 | 2.18380E−10 | −1.13280E−11 | 3.16140E−13 | −3.66430E−15 | 0.00E+00 |
| Rp2 | 0.00000E+00 | 0.00000E+00 | 0.00000E+00 | 0.00000E+00 | 0.00000E+00 | 0.00E+00 |
| R1 | −4.03332E+00 | −1.27320E−06 | 1.88880E−07 | −1.73520E−08 | 8.97950E−10 | −2.01E−11 |
| R2 | −6.79743E−01 | −1.63210E−06 | 2.28440E−07 | −2.07050E−08 | 1.08010E−09 | −2.48E−11 |
| R3 | −1.63988E+01 | −3.24160E−07 | 9.77560E−09 | 2.27050E−10 | −2.03420E−11 | 0.00E+00 |
| R4 | 9.14570E−01 | −7.40100E−07 | 6.54370E−08 | −3.19210E−09 | 6.44090E−11 | 0.00E+00 |
| R5 | −2.43026E+01 | 6.71900E−06 | −5.09760E−07 | 2.23050E−08 | −4.22890E−10 | 0.00E+00 |
| R6 | 2.81020E+01 | −2.02380E−05 | 4.52450E−06 | −7.56470E−07 | 9.56320E−08 | −8.87E−09 |
| R7 | −6.04916E+00 | 4.76430E−05 | −1.43020E−05 | 2.99800E−06 | −4.36460E−07 | 4.32E−08 |
| R8 | 1.58703E+01 | 2.62610E−05 | −5.05940E−06 | 5.97450E−07 | −3.04470E−08 | −1.95E−09 |
| R9 | −5.29380E−01 | 2.95900E−04 | −8.00870E−05 | 1.56360E−05 | −2.18720E−06 | 2.13E−07 |
| R10 | −9.17634E+00 | −5.62800E−05 | 1.24740E−05 | −2.12750E−06 | 2.62270E−07 | −2.23E−08 |

| | Conic | | | |
|---|---|---|---|---|
| | coefficient | Aspheric coefficient | | |
| | K | A24 | A26 | A28 |
| Rp1 | −7.24243E+00 | 0.00E+00 | 0.00E+00 | 0.00E+00 |
| Rp2 | 0.00000E+00 | 0.00E+00 | 0.00E+00 | 0.00E+00 |
| R1 | −4.03332E+00 | 0.00E+00 | 0.00E+00 | 0.00E+00 |
| R2 | −6.79743E−01 | 0.00E+00 | 0.00E+00 | 0.00E+00 |
| R3 | −1.63988E+01 | 0.00E+00 | 0.00E+00 | 0.00E+00 |
| R4 | 9.14570E−01 | 0.00E+00 | 0.00E+00 | 0.00E+00 |
| R5 | −2.43026E+01 | 0.00E+00 | 0.00E+00 | 0.00E+00 |
| R6 | 2.81020E+01 | 5.64E−10 | −2.18E−11 | 3.80E−13 |
| R7 | −6.04916E+00 | −2.76E−09 | 1.03E−10 | −1.68E−12 |
| R8 | 1.58703E+01 | 4.20E−10 | −2.64E−11 | 6.12E−13 |
| R9 | −5.29380E−01 | −1.37E−08 | 5.21E−10 | −8.76E−12 |
| R10 | −9.17634E+00 | 1.24E−09 | −4.01E−11 | 5.76E−13 |

In addition, in the subsequent Table 19, the values corresponding to the parameters specified in the relationship formulas and various parameters in the fourth embodiment are also listed.

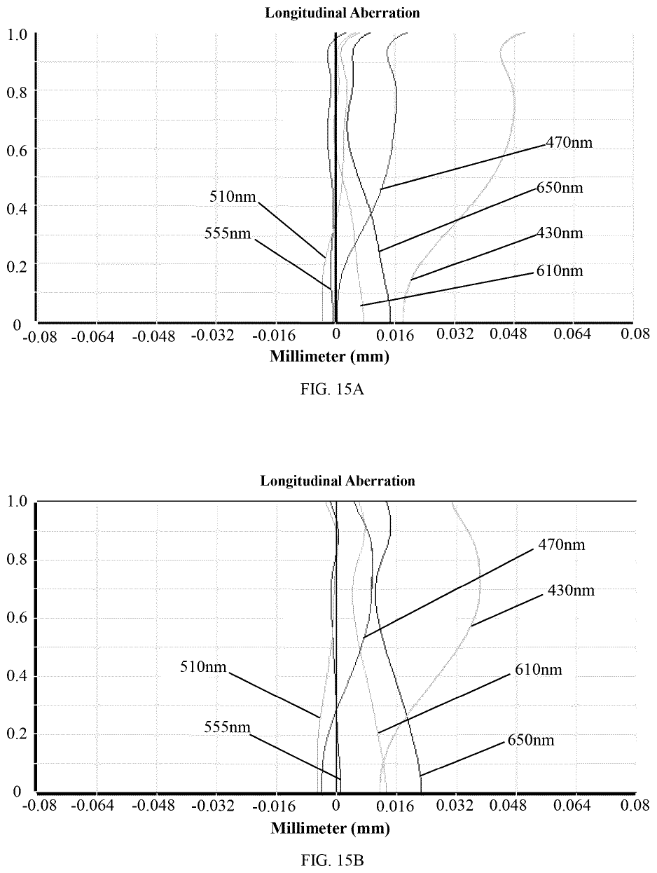

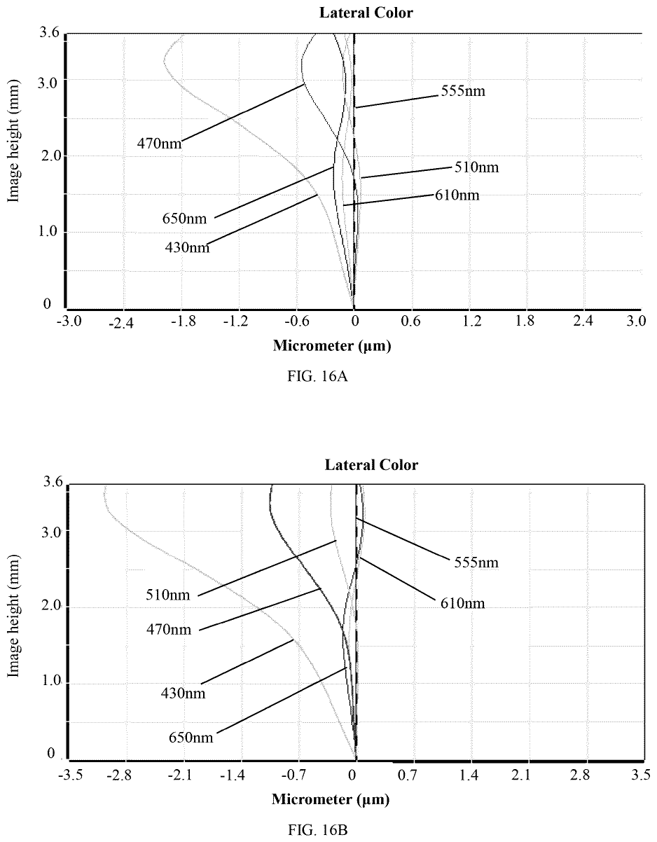

FIG. 14A and FIG. 14B show schematic diagrams of the field curvature and distortion of light with of 555 nm after passing through the imaging optical lens 40 of the fourth embodiment. FIG. 15A and FIG. 15B show schematic diagrams of the longitudinal aberration of light with wavelengths of 430 nm, 470 nm, 510 nm, 555 nm, 610 nm, and 650 nm after passing through the imaging optical lens 40 of the fourth embodiment. FIG. 16A and FIG. 16B show schematic diagrams of the lateral color of light with wavelengths of 430 nm, 470 nm, 510 nm, 555 nm, 610 nm, and 650 nm after passing through the imaging optical lens 40 of the fourth embodiment.

As shown in Table 19, the fourth embodiment satisfies all the relationship formulas.

In an embodiment, the entrance pupil diameter of the imaging optical lens 40 in the first state is 7.035 mm, the full-field image height is 3.600 mm, and the diagonal field of view is 24.85°. The imaging optical lens 40 has the characteristics of a large aperture, long focal length, and miniaturization, with its on-axis and off-axis chromatic aberrations are fully corrected, and excellent optical performance.

### Fifth Embodiment

The first prism P1, has positive refractive power, with its object-side surface being convex in the paraxial region and its image-side surface being convex in the paraxial region;
the first lens L1, has negative refractive power, with its object-side surface being convex in the paraxial region and its image-side surface being concave in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being concave in the paraxial region; and
the fifth lens L5, has negative refractive power, with its object-side surface being convex in the paraxial region and its image-side surface being concave in the paraxial region.

FIG. 17A and FIG. 17B are schematic diagrams showing the structure of the imaging optical lens 50 in the fifth embodiment. The fifth embodiment is basically the same as the first embodiment, and the meanings of the symbols are the same as those in the first embodiment. Only the differences are listed below.

Tables 13-15 show the design data of the imaging optical lens 50 according to the fifth embodiment of the present invention.

TABLE 13

| | R | d | | nd | | vd | |
|---|---|---|---|---|---|---|---|
| ST | ∞ | d0= | −9.530 | | | | |
| Rp1 | 34.675 | dp1= | 9.500 | nd1 | 1.8052 | vd1 | 40.89 |
| Rp2 | −17.338 | dp2= | dp2 | | | | |
| R1 | 6.823 | d1= | 1.301 | nd2 | 1.6400 | vd2 | 23.54 |
| R2 | 3.764 | d2= | 0.812 | | | | |
| R3 | 7.084 | d3= | 2.065 | nd3 | 1.5444 | vd3 | 55.82 |
| R4 | −7.858 | d4= | d4 | | | | |
| R5 | −6.072 | d5= | 1.293 | nd4 | 1.6153 | vd4 | 25.94 |
| R6 | 20.815 | d6= | 1.844 | | | | |
| R7 | 6.945 | d7= | 1.846 | nd5 | 1.6700 | vd5 | 19.39 |
| R8 | 14.256 | d8= | 1.858 | | | | |
| R9 | 5.112 | d9= | 0.675 | nd6 | 1.5346 | vd6 | 55.70 |
| R10 | 3.716 | d10= | 2.782 | | | | |
| R11 | ∞ | d11= | 0.210 | ndg | 1.5168 | νg | 64.17 |
| R12 | ∞ | d12= | 0.613 | | | | |

Herein, dp11=“dp1-01”+“dp1-02”, “dp1-01”=4.9, “dp1-02”=4.6.

Table 14 lists relevant optical parameters of the imaging optical lens 50 in the fifth embodiment of the present disclosure in the first state and the second state respectively.

TABLE 14

| | In the first state | In the second state |
|---|---|---|
| f | 15.876 | 14.4 |
| FOV | 24.95° | 24.56° |
| FNO | 2.25 | 2.49 |
| dp2 | 0.606 | 0.1 |
| d4 | 0.094 | 0.6 |

Table 15 lists the conic coefficients k and aspherical coefficients of the imaging optical lens 50 in the fifth embodiment of the present disclosure.

TABLE 15

| | Conic | | | | | |
|---|---|---|---|---|---|---|
| | coefficient | Aspheric coefficient | | | | |
| | K | A4 | A6 | A8 | A10 | A12 |
| Rp1 | −1.10864E+01 | 2.49390E−05 | −9.97990E−07 | −3.13540E−08 | 1.69570E−08 | −2.92460E−09 |
| Rp2 | 0.00000E+00 | 0.00000E+00 | 0.00000E+00 | 0.00000E+00 | 0.00000E+00 | 0.00000E+00 |
| R1 | −3.96141E+00 | −2.96780E−03 | −1.33920E−04 | 5.10340E−05 | −2.04160E−05 | 6.44360E−06 |
| R2 | −6.83970E−01 | −7.15090E−03 | −3.05600E−04 | 1.19920E−04 | −3.81540E−05 | 1.05010E−05 |
| R3 | −1.65702E+01 | 3.97910E−03 | −1.14180E−03 | 2.12810E−04 | −4.20840E−05 | 7.35680E−06 |
| R4 | 9.49560E−01 | 2.61520E−04 | −1.74170E−04 | 9.51950E−05 | −3.21250E−05 | 7.11120E−06 |
| R5 | −2.39351E+01 | −1.03280E−02 | 3.79550E−03 | −1.08340E−03 | 2.40920E−04 | −3.95490E−05 |
| R6 | 2.62584E+01 | −2.80410E−03 | 6.89140E−04 | −5.94040E−07 | −1.22940E−04 | 8.38140E−05 |
| R7 | −5.70259E+00 | −3.88900E−03 | 9.00180E−04 | −4.96050E−04 | 4.04120E−04 | −2.48200E−04 |
| R8 | 9.87118E+00 | −8.45370E−03 | 1.85520E−03 | −6.93240E−04 | 3.20920E−04 | −1.22270E−04 |
| R9 | −5.19135E−01 | −3.51980E−02 | 4.09290E−03 | −3.10560E−03 | 2.95440E−03 | −1.80820E−03 |
| R10 | −1.04090E+01 | −1.16940E−02 | −3.35560E−03 | 1.89500E−03 | −4.96710E−04 | 8.03540E−05 |

| | Conic | | | | | |
|---|---|---|---|---|---|---|
| | coefficient | Aspheric coefficient | | | | |
| | K | A14 | A16 | A18 | A20 | A22 |
| Rp1 | −1.10864E+01 | 2.72930E−10 | −1.43820E−11 | 4.01660E−13 | −4.62520E−15 | 0.00E+00 |
| Rp2 | 0.00000E+00 | 0.00000E+00 | 0.00000E+00 | 0.00000E+00 | 0.00000E+00 | 0.00E+00 |
| R1 | −3.96141E+00 | −1.36050E−06 | 1.86800E−07 | −1.60140E−08 | 7.78980E−10 | −1.64E−11 |
| R2 | −6.83970E−01 | −2.00010E−06 | 2.56230E−07 | −2.09160E−08 | 9.80420E−10 | −2.03E−11 |
| R3 | −1.65702E+01 | −9.13350E−07 | 7.75100E−08 | −3.90860E−09 | 8.43380E−11 | 0.00E+00 |
| R4 | 9.49560E−01 | −9.97180E−07 | 8.70400E−08 | −4.24730E−09 | 8.80210E−11 | 0.00E+00 |
| R5 | −2.39351E+01 | 4.53980E−06 | −3.41080E−07 | 1.49200E−08 | −2.85630E−10 | 0.00E+00 |
| R6 | 2.62584E+01 | −3.63570E−05 | 1.12440E−05 | −2.48970E−06 | 3.88180E−07 | −4.14E−08 |
| R7 | −5.70259E+00 | 1.05070E−04 | −3.08250E−05 | 6.31190E−06 | −8.98230E−07 | 8.69E−08 |
| R8 | 9.87118E+00 | 3.30210E−05 | −5.81500E−06 | 5.55760E−07 | 3.12590E−10 | −7.29E−09 |
| R9 | −5.19135E−01 | 7.51290E−04 | −2.19690E−04 | 4.57150E−05 | −6.72740E−06 | 6.83E−07 |
| R10 | −1.04090E+01 | −9.89410E−06 | 1.84390E−06 | −4.75510E−07 | 8.81700E−08 | −1.02E−08 |

| | Conic | | | |
|---|---|---|---|---|
| | coefficient | Aspheric coefficient | | |
| | K | A24 | A26 | A28 |
| Rp1 | −1.10864E+01 | 0.00E+00 | 0.00E+00 | 0.00E+00 |
| Rp2 | 0.00000E+00 | 0.00E+00 | 0.00E+00 | 0.00E+00 |
| R1 | −3.96141E+00 | 0.00E+00 | 0.00E+00 | 0.00E+00 |
| R2 | −6.83970E−01 | 0.00E+00 | 0.00E+00 | 0.00E+00 |
| R3 | −1.65702E+01 | 0.00E+00 | 0.00E+00 | 0.00E+00 |
| R4 | 9.49560E−01 | 0.00E+00 | 0.00E+00 | 0.00E+00 |
| R5 | −2.39351E+01 | 0.00E+00 | 0.00E+00 | 0.00E+00 |
| R6 | 2.62584E+01 | 2.87E−09 | −1.17E−10 | 2.11E−12 |
| R7 | −5.70259E+00 | −5.45E−09 | 1.99E−10 | −3.21E−12 |
| R8 | 9.87118E+00 | 9.12E−10 | −5.07E−11 | 1.12E−12 |
| R9 | −5.19135E−01 | −4.55E−08 | 1.78E−09 | −3.09E−11 |
| R10 | −1.04090E+01 | 7.07E−10 | −2.74E−11 | 4.57E−13 |

In addition, in the subsequent Table 19, the values corresponding to the parameters specified in the relationship formulas and various parameters in the fifth embodiment are also listed.

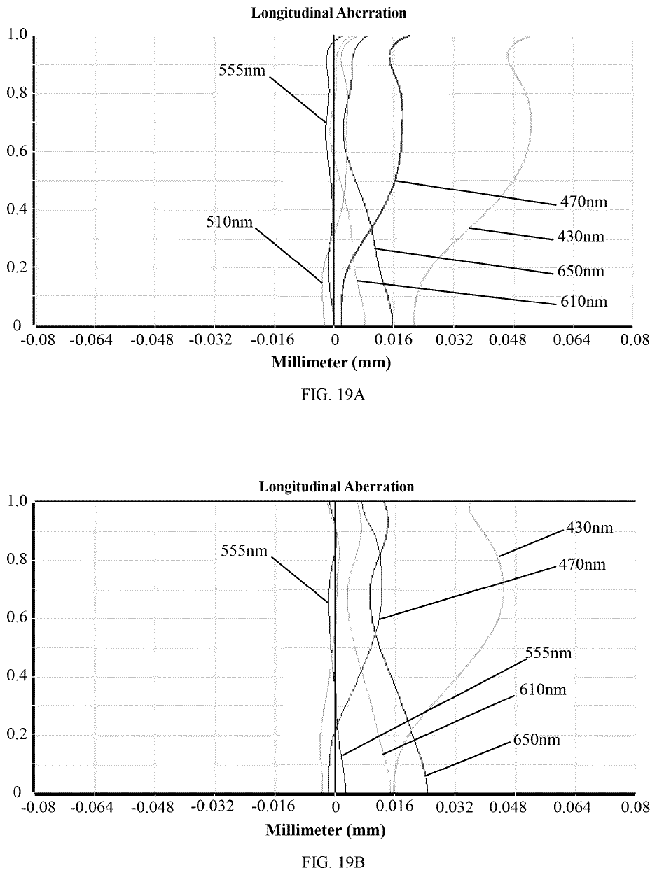

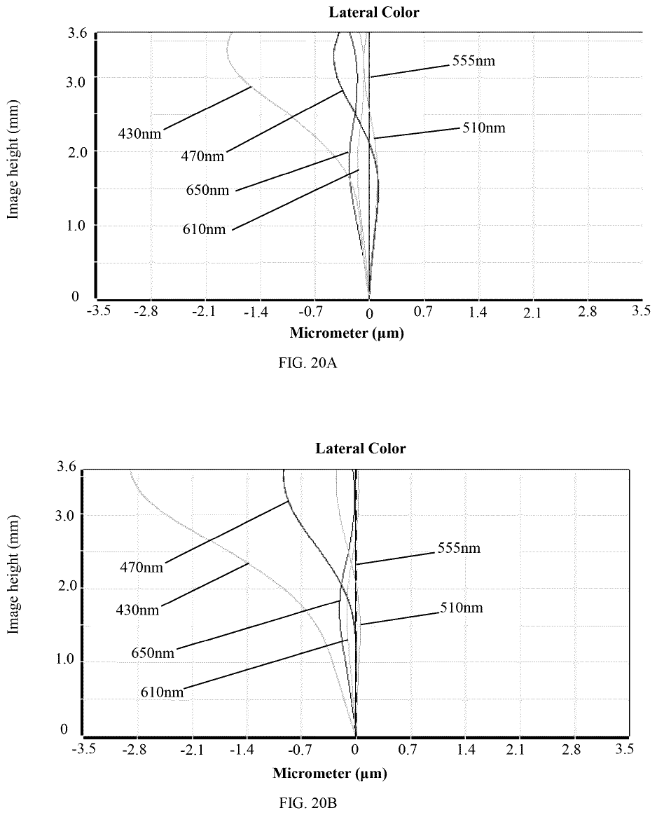

FIG. 18A and FIG. 18B show schematic diagrams of the field curvature and distortion of light with of 555 nm after passing through the imaging optical lens 50 of the fifth embodiment. FIG. 19A and FIG. 19B show schematic diagrams of the longitudinal aberration of light with wavelengths of 430 nm, 470 nm, 510 nm, 555 nm, 610 nm, and 650 nm after passing through the imaging optical lens 50 of the fifth embodiment. FIG. 20A and FIG. 20B show schematic diagrams of the lateral color of light with wavelengths of 430 nm, 470 nm, 510 nm, 555 nm, 610 nm, and 650 nm after passing through the imaging optical lens 50 of the fifth embodiment.

As shown in Table 19, the fifth embodiment satisfies all the relationship formulas.

In an embodiment, the entrance pupil diameter of the imaging optical lens 50 in the first state is 7.068 mm, the full-field image height is 3.600 mm, and the diagonal field of view is 24.95°. The imaging optical lens 50 has the characteristics of a large aperture, long focal length, and miniaturization, with its on-axis and off-axis chromatic aberrations are fully corrected, and excellent optical performance.

### Sixth Embodiment

The first prism P1, has positive refractive power, with its object-side surface being convex in the paraxial region and its image-side surface being convex in the paraxial region;
the first lens L1, has negative refractive power, with its object-side surface being convex in the paraxial region and its image-side surface being concave in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being concave in the paraxial region; and
the fifth lens L5, has negative refractive power, with its object-side surface being convex in the paraxial region and its image-side surface being concave in the paraxial region.

FIG. 21A and FIG. 21B are schematic diagrams showing the structure of the imaging optical lens 60 in the sixth embodiment. The sixth embodiment is basically the same as the first embodiment, and the meanings of the symbols are the same as those in the first embodiment. Only the differences are listed below.

Tables 16-18 show the design data of the imaging optical lens 60 according to the sixth embodiment of the present invention.

TABLE 16

| | R | d | | nd | | vd | |
|---|---|---|---|---|---|---|---|
| ST | ∞ | d0= | −9.530 | | | | |
| Rp1 | 54.162 | dp1= | 9.500 | nd1 | 1.8052 | vd1 | 40.89 |
| Rp2 | −13.888 | dp2= | dp2 | | | | |
| R1 | 6.855 | d1= | 1.380 | nd2 | 1.6400 | vd2 | 23.54 |
| R2 | 3.721 | d2= | 0.809 | | | | |
| R3 | 7.061 | d3= | 2.056 | nd3 | 1.5444 | vd3 | 55.82 |
| R4 | −7.884 | d4= | d4 | | | | |
| R5 | −6.135 | d5= | 0.508 | nd4 | 1.6153 | vd4 | 25.94 |
| R6 | 19.523 | d6= | 2.646 | | | | |
| R7 | 8.381 | d7= | 1.058 | nd5 | 1.6700 | vd5 | 19.39 |
| R8 | 27.006 | d8= | 2.430 | | | | |
| R9 | 5.055 | d9= | 0.678 | nd6 | 1.5346 | vd6 | 55.70 |
| R10 | 3.574 | d10= | 2.865 | | | | |
| R11 | ∞ | d11= | 0.210 | ndg | 1.5168 | νg | 64.17 |
| R12 | ∞ | d12= | 0.654 | | | | |

Herein, dp11=“dp1-01”+“dp1-02”, “dp1-01”=4.9, “dp1-02”=4.6.

Table 17 lists relevant optical parameters of the imaging optical lens 60 in the sixth embodiment of the present disclosure in the first state and the second state respectively.

TABLE 17

| | In the first state | In the second state |
|---|---|---|
| f | 15.771 | 14.4 |
| FOV | 25.11° | 24.77° |
| FNO | 2.28 | 2.50 |
| dp2 | 0.576 | 0.104 |
| d4 | 0.132 | 0.604 |

Table 18 lists the conic coefficients k and aspherical coefficients of the imaging optical lens 60 in the sixth embodiment of the present disclosure.

TABLE 18

| | Conic | | | | | |
|---|---|---|---|---|---|---|
| | coefficient | Aspheric coefficient | | | | |
| | K | A4 | A6 | A8 | A10 | A12 |
| Rp1 | −3.28740E+01 | −2.29460E−07 | −1.98820E−06 | 5.21850E−08 | 4.76140E−09 | −1.74760E−09 |
| Rp2 | 0.00000E+00 | 0.00000E+00 | 0.00000E+00 | 0.00000E+00 | 0.00000E+00 | 0.00000E+00 |
| R1 | −3.72767E+00 | −2.95280E−03 | −7.65050E−05 | 1.41450E−05 | −2.37650E−06 | 5.39080E−07 |
| R2 | −6.70236E−01 | −7.28290E−03 | −1.66560E−04 | 4.30910E−05 | −2.73320E−06 | −4.89990E−07 |
| R3 | −1.54797E+01 | 3.53970E−03 | −9.28230E−04 | 1.40960E−04 | −1.73160E−05 | 1.68180E−06 |
| R4 | 7.20381E−01 | 2.60260E−04 | −2.13830E−04 | 1.34230E−04 | −4.50760E−05 | 9.51960E−06 |
| R5 | −2.33153E+01 | −1.10760E−02 | 4.12740E−03 | −1.10420E−03 | 2.08110E−04 | −2.56820E−05 |
| R6 | 2.97415E+01 | −3.12820E−03 | 1.20230E−03 | −2.21950E−04 | −4.15540E−06 | 1.19250E−06 |
| R7 | −5.70196E+00 | −4.63110E−03 | 9.71270E−04 | −5.07290E−04 | 4.17670E−04 | −2.50990E−04 |
| R8 | 4.13512E+01 | −7.30240E−03 | 1.33630E−03 | −3.15280E−04 | 8.46670E−05 | −1.36460E−05 |
| R9 | −2.05581E−01 | −3.05970E−02 | 2.53330E−03 | −1.67080E−03 | 1.57880E−03 | −9.22960E−04 |
| R10 | −8.15973E+00 | −1.14680E−02 | −2.54020E−03 | 1.46140E−03 | −4.11200E−04 | 8.55910E−05 |

| | Conic | | | | | |
|---|---|---|---|---|---|---|
| | coefficient | Aspheric coefficient | | | | |
| | K | A14 | A16 | A18 | A20 | A22 |
| Rp1 | −3.28740E+01 | 2.06600E−10 | −1.26060E−11 | 3.94090E−13 | −4.99310E−15 | 0.00E+00 |
| Rp2 | 0.00000E+00 | 0.00000E+00 | 0.00000E+00 | 0.00000E+00 | 0.00000E+00 | 0.00E+00 |
| R1 | −3.72767E+00 | −9.58020E−08 | 1.12010E−08 | −8.00140E−10 | 3.22710E−11 | −6.04E−13 |
| R2 | −6.70236E−01 | 2.38590E−07 | −4.36690E−08 | 4.78220E−09 | −3.01900E−10 | 8.02E−12 |
| R3 | −1.54797E+01 | −1.20080E−07 | 1.34990E−08 | −1.21000E−09 | 3.98180E−11 | 0.00E+00 |
| R4 | 7.20381E−01 | −1.25820E−06 | 1.03540E−07 | −4.80180E−09 | 9.61090E−11 | 0.00E+00 |
| R5 | −2.33153E+01 | 1.82710E−06 | −4.83020E−08 | −1.94310E−09 | 1.21430E−10 | 0.00E+00 |
| R6 | 2.97415E+01 | 6.70450E−06 | −3.70180E−06 | 1.00900E−06 | −1.70210E−07 | 1.87E−08 |
| R7 | −5.70196E+00 | 1.03010E−04 | −2.92000E−05 | 5.77180E−06 | −7.93140E−07 | 7.42E−08 |
| R8 | 4.13512E+01 | −1.21130E−06 | 1.39130E−06 | −4.06370E−07 | 6.88740E−08 | −7.45E−09 |
| R9 | −2.05581E−01 | 3.62630E−04 | −1.00290E−04 | 1.97890E−05 | −2.76990E−06 | 2.68E−07 |
| R10 | −8.15973E+00 | −1.65890E−05 | 3.33270E−06 | −5.99230E−07 | 8.08710E−08 | −7.47E−09 |

| | Conic | | | |
|---|---|---|---|---|
| | coefficient | Aspheric coefficient | | |
| | K | A24 | A26 | A28 |
| Rp1 | −3.28740E+01 | 0.00E+00 | 0.00E+00 | 0.00E+00 |
| Rp2 | 0.00000E+00 | 0.00E+00 | 0.00E+00 | 0.00E+00 |
| R1 | −3.72767E+00 | 0.00E+00 | 0.00E+00 | 0.00E+00 |
| R2 | −6.70236E−01 | 0.00E+00 | 0.00E+00 | 0.00E+00 |
| R3 | −1.54797E+01 | 0.00E+00 | 0.00E+00 | 0.00E+00 |
| R4 | 7.20381E−01 | 0.00E+00 | 0.00E+00 | 0.00E+00 |
| R5 | −2.33153E+01 | 0.00E+00 | 0.00E+00 | 0.00E+00 |
| R6 | 2.97415E+01 | −1.30E−09 | 5.29E−11 | −9.51E−13 |
| R7 | −5.70196E+00 | −4.50E−09 | 1.60E−10 | −2.51E−12 |
| R8 | 4.13512E+01 | 5.08E−10 | −2.00E−11 | 3.47E−13 |
| R9 | −2.05581E−01 | −1.71E−08 | 6.40E−10 | −1.07E−11 |
| R10 | −8.15973E+00 | 4.42E−10 | −1.51E−11 | 2.27E−13 |

In addition, in the subsequent Table 19, the values corresponding to the parameters specified in the relationship formulas and various parameters in the sixth embodiment are also listed.

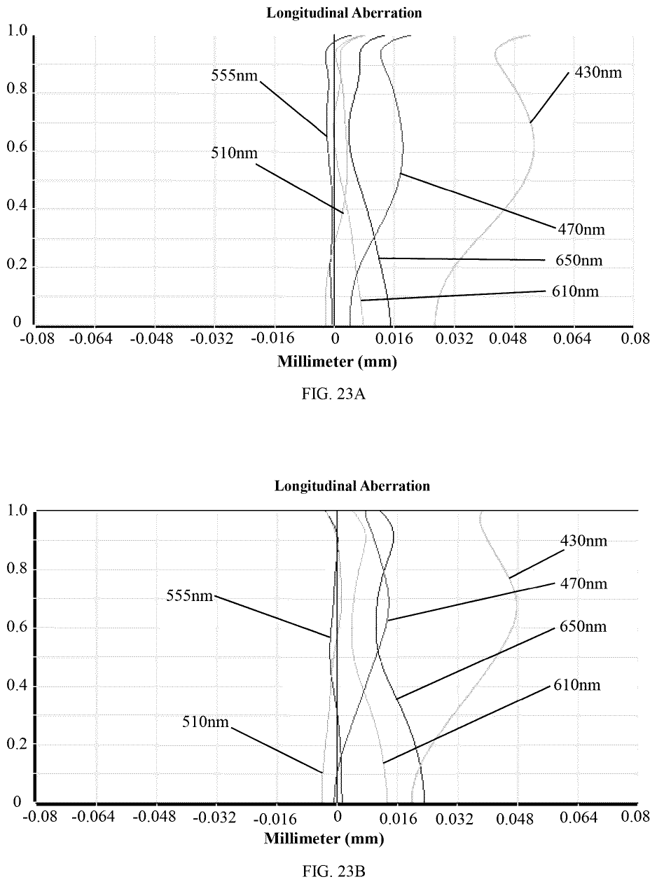

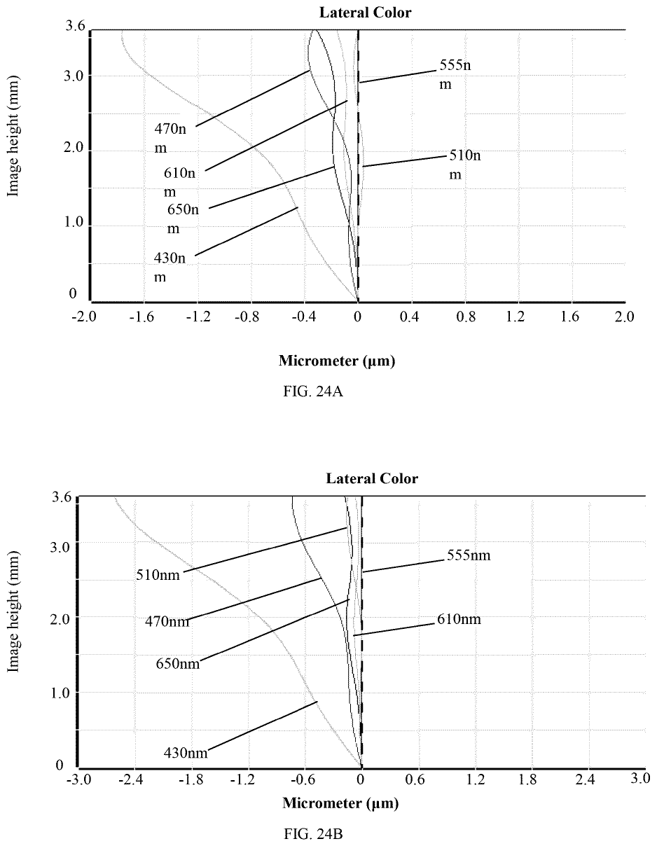

FIG. 22A and FIG. 22B show schematic diagrams of the field curvature and distortion of light with of 555 nm after passing through the imaging optical lens 60 of the sixth embodiment. FIG. 23A and FIG. 23B show schematic diagrams of the longitudinal aberration of light with wavelengths of 430 nm, 470 nm, 510 nm, 555 nm, 610 nm, and 650 nm after passing through the imaging optical lens 60 of the sixth embodiment. FIG. 24A and FIG. 24B show schematic diagrams of the lateral color of light with wavelengths of 430 nm, 470 nm, 510 nm, 555 nm, 610 nm, and 650 nm after passing through the imaging optical lens 60 of the sixth embodiment.

As shown in Table 19, the sixth embodiment satisfies all the relationship formulas.

In an embodiment, the entrance pupil diameter of the imaging optical lens 60 in the first state is 6.904 mm, the full-field image height is 3.600 mm, and the diagonal field of view is 25.11°. The imaging optical lens 60 has the characteristics of a large aperture, long focal length, and miniaturization, with its on-axis and off-axis chromatic aberrations are fully corrected, and excellent optical performance.

TABLE 19

| Parameters Relationship | First | Second | Third |
|---|---|---|---|
| formula | Embodiment | Embodiment | Embodiment |
| fA/IH | 4.52 | 4.45 | 4.44 |
| Rp1/Rp2 | −0.14 | −0.65 | −1.13 |
| (R7 + R8)/(R7 − R8) | −1.60 | −2.00 | −1.20 |
| d1/d3 | 0.30 | 1.20 | 0.70 |
| d5/d7 | 0.93 | 0.96 | 1.14 |
| fA | 16.287 | 16.025 | 16.000 |
| fp1 | 19.944 | 17.994 | 16.729 |
| f1 | −16.467 | −15.964 | −15.090 |
| f2 | 6.727 | 6.608 | 6.784 |
| f3 | −7.334 | −7.319 | −7.390 |
| f4 | 16.097 | 17.742 | 15.984 |
| f5 | −21.161 | −27.381 | −21.419 |
| TTL | 25.501 | 25.407 | 25.500 |
| Parameters Relationship | Fourth | Fifth | Sixth |
| formula | Embodiment | Embodiment | Embodiment |
| fA/IH | 4.43 | 4.41 | 4.38 |
| Rp1/Rp2 | −1.30 | −2.00 | −3.90 |
| (R7 + R8)/(R7 − R8) | −2.40 | −2.90 | −1.90 |
| d1/d3 | 0.57 | 0.63 | 0.67 |
| d5/d7 | 0.30 | 0.70 | 0.48 |
| fA | 15.941 | 15.876 | 15.771 |
| fp1 | 16.659 | 15.562 | 14.577 |
| f1 | −15.790 | −15.623 | −15.251 |
| f2 | 7.037 | 7.171 | 7.168 |
| f3 | −7.455 | −7.451 | −7.478 |
| f4 | 17.783 | 18.176 | 17.570 |
| f5 | −29.695 | −30.532 | −27.060 |
| TTL | 25.498 | 25.499 | 25.502 |

The imaging optical lens provided in the embodiments of the present disclosure is introduced in detail above. The principles and implementations of the present disclosure are explained herein by examples. The description of the above embodiments are only used to help understand the idea of the present disclosure. There may be changes in the implementations and the scope of application. In summary, the content of this specification should not be construed as limiting the present disclosure.

What is claimed is:

1. An imaging optical lens, comprising:
in sequence from the object-side to the image-side:
a first prism with positive refractive power;
a first lens with negative refractive power;
a second lens with positive refractive power;
a third lens with negative refractive power;
a fourth lens with positive refractive power; and
a fifth lens with negative refractive power;
wherein:
a reflective surface is arranged between the object-side surface and the image-side surface of the first prism;
the first lens and the second lens form a first lens group, and the third lens, the fourth lens, and the fifth lens form a second lens group, the first lens group is configured to be movable along the optical axis of the imaging optical lens for adjustment, enabling the imaging optical lens to switch between a first state and a second state, wherein the imaging optical lens has a maximum focal length in the first state and a minimum focal length in the second state;
and wherein:
fA represents a focal length of the imaging optical lens in the first state;
IH represents an image height of the imaging optical lens;
Rp1 represents a curvature radius of the object-side surface of the first prism;
Rp2 represents a curvature radius of the image-side surface of the first prism;
d1 represents an on-axis thickness of the first lens, d3 represents an on-axis thickness of the second lens;
R7 represents a curvature radius of the object-side surface of the fourth lens;
R8 represents a curvature radius of the image-side surface of the fourth lens;
and the imaging optical lens satisfies the following relationships:
$$4. \leq fA / IH \leq 4.6 ;$$
$$- 4. 0 \leq Rp 1 / Rp 2 \leq - 0 \text{.14} ;$$
$$0.3 \leq d 1 / d 3 \leq 1.2 ;$$
$$- 2.9 \; 0 \leq ( R 7 + R 8 ) / ( R 7 - R 8 ) \leq - 1.20 .$$

2. The imaging optical lens of claim 1, wherein the imaging optical lens satisfies the following relationships:
$$4.38 \leq fA / IH \leq 4.53 ;$$
$$- 3.9 \leq Rp 1 / Rp 2 \leq - 0.14 ;$$
$$- 2.9 \; 0 \leq ( R 7 + R 8 ) / ( R 7 - R 8 ) \leq - 1.19 .$$

3. The imaging optical lens of claim 1, wherein an object-side surface of the first prism is convex in a paraxial region, and an image-side surface of the first prism is convex in a paraxial region; fp1 represents a focal length of the first prism; and the imaging optical lens satisfies the following relationship:
$$0.92 \leq fp 1 / fA \leq 1.23 .$$

4. The imaging optical lens of claim 1, wherein an object-side surface of the first lens is convex in a paraxial region, and an image-side surface of the first lens is concave in a paraxial region;
f1 represents a focal length of the first lens, R1 represents a curvature radius of the object-side surface of the first lens, R2 represents a curvature radius of the image-side surface of the first lens, TTL represents a total optical length of the imaging optical lens; and the imaging optical lens further satisfies the following relationships:
$$- 1.012 \leq f 1 / fA \leq - 0.943 ;$$
$$3.33 \leq ( R 1 + R 2 ) / ( R 1 - R 2 ) \leq 4. ;$$
$$0.034 \leq d 1 / TTL \leq 0.061 .$$

5. The imaging optical lens of claim 1, wherein an object-side surface of the second lens is convex in a paraxial region, and an image-side surface of the second lens is convex in a paraxial region;
f2 represents a focal length of the second lens, R3 represents a curvature radius of the object-side surface of the second lens, R4 represents a curvature radius of the image-side surface of the second lens, TTL represents a total optical length of the imaging optical lens;
$$0.412 \leq f 2 / fA \leq 0. 455 ;$$
$$- 0.094 \leq ( R 3 + R 4 ) / ( R 3 - R 4 ) \leq - 0.038 ;$$
$$0.05 \leq d 3 / TTL \leq 0.115 .$$

6. The imaging optical lens of claim 1, wherein an object-side surface of the third lens is concave in a paraxial region, and an image-side surface of the third lens is concave in a paraxial region;
f3 represents a focal length of the third lens, R5 represents a curvature radius of the object-side surface of the third lens, R6 represents a curvature radius of the image-side surface of the third lens, d5 represents an on-axis thickness of the third lens, TTL represents a total optical length of the imaging optical lens;
and the imaging optical lens satisfies the following relationships:
$$- 0.475 \leq f 3 / fA \leq - 0.4 \; 50 ;$$
$$- 0.58 \leq ( R 5 + R 6 ) / ( R 5 - R 6 ) \leq - 0.44 ;$$
$$0.019 \leq d 5 / TTL \leq 0.095 .$$

7. The imaging optical lens of claim 1, wherein an object-side surface of the fourth lens is convex in a paraxial region, and an image-side surface of the fourth lens is concave in a paraxial region;
f4 represents a focal length of the fourth lens, d7 represents an on-axis thickness of the fourth lens, TTL represents a total optical length of the imaging optical lens;
and the imaging optical lens satisfies the following relationships:
$$0.98 \leq f 4 / fA \leq 1.15 ;$$
$$0.041 \leq d 7 / TTL \leq 0.103 .$$

8. The imaging optical lens of claim 1, wherein d5 represents an on-axis thickness of the third lens, d7 represents an on-axis thickness of the fourth lens;
and the imaging optical lens satisfies the following relationship:
$$0.25 \leq d 5 / d 7 \leq 1.15 .$$

9. The imaging optical lens of claim 8, wherein the imaging optical lens satisfies the following relationship: 0.29≤d5/d7≤1.15.

10. The imaging optical lens of claim 1, wherein an object-side surface of the fifth lens is convex in a paraxial region, and an image-side surface of the fifth lens is concave in a paraxial region;
f5 represents a focal length of the fifth lens, R9 represents a curvature radius of the object-side surface of the fifth lens, R10 represents a curvature radius of the image-side surface of the fifth lens;
and the imaging optical lens satisfies the following relationships:
$$- 1.93 \leq f 5 / fA \leq - 1.29 ;$$
$$4.31 \leq ( R 9 + R 10 ) / ( R 9 - R 10 ) \leq 6.33 .$$

11. The imaging optical lens of claim 1, wherein the first prism is made of glass.
